(19) United States
(12) Patent Application Publication
(10) Pub. No.: US 2016/0230452 A1
(43) Pub. Date: Aug. 11, 2016

(54) OPENING/CLOSING APPARATUS FOR OPENING PORTION

(71) Applicant: OILES ECO CORPORATION, Tokyo (JP)

(72) Inventors: Kazuharu TANABE, Tokyo (JP); Mamoru OHISHI, Tokyo (JP); Tetsuya HIRATSUKA, Omihachiman-shi, Shiga (JP)

(21) Appl. No.: 15/023,011

(22) PCT Filed: Sep. 18, 2014
(86) PCT No.: PCT/JP2014/004816

§ 371 Date: Mar. 18, 2016

(30) Foreign Application Priority Data
Sep. 27, 2013 (JP) 2013-202621

(51) Int. Cl. E06B 9/302; E06B 9/06

(52) U.S. Cl. CPC E06B 9/302; E06B 9/0638

(57) ABSTRACT

A window blind apparatus 1 includes a frame body 3 disposed in an opening portion 2; a plurality of slats 4 for opening and closing the opening portion 2; a link mechanism 5 for mutually connecting the slats 4; a raising and lowering mechanism 9 for raising and lowering the plurality of slats 4 in opening and closing the opening portion 2, by raising the slats 4, starting with a lowermost slat 8, and by lowering the slats 4, starting with the lowermost slat 8; and a reaction force generating mechanism 10 for imparting to the raising and lowering mechanism 9 a reaction force which is oriented in a direction opposite to the direction of the load of the slats 4 in the opening portion 2 and which increases or decreases in correspondence with an increase or decrease of the load of the slats 4 in the opening portion 2 corresponding to the number of the slats 4 being raised or lowered by the raising and lowering mechanism 9 in the opening portion 2.

### TECHNICAL FIELD

The present invention relates to an opening/closing apparatus for an opening portion, such as a window blind apparatus or a shutter apparatus which is disposed in an opening portion such as a window or an entrance of a building and is used to open and close the opening portion.

### BACKGROUND ART

As described in Patent Document 1, for example, a window blind apparatus comprises: a frame body which is disposed in an opening portion, such as a window, of a building; a plurality of slats juxtaposed to each other in an opening portion surrounded by the frame body; a suspending mechanism for suspending an uppermost slat among the plurality of slats; a link mechanism which links the plurality of slats to each other and is foldable; and a raising and lowering mechanism for raising and lowering the plurality of slats by raising them, starting with a lowermost slat among the plurality of slats, and by lowering them, starting with the lowermost slat.

### PRIOR ART DOCUMENTS

### Patent Documents

Patent Document 1: Republication of WO2011/09907

Patent Document 2: JP-A-2011432806

### SUMMARY OF THE INVENTION

### Problems to be Solved by the Invention

Incidentally, in such a window blind apparatus, the raising and lowering of the plurality of slats in the opening and closing of the opening portion is automatically effected by an electric motor. However, in both cases where, in substitution for the electric motor, a pulley is secured to a rotating shaft, a cord or a ball chain is wound around the pulley, and through the manual traveling of the cord or the ball chain for raising and lowering the slats, the opening portion closed by the plurality of slats is arranged to be opened by raising the slats, starting with a lowermost slat and where the opened opening portion is arranged to be closed by raising the slats, starting with an uppermost slat, the load of the slats increases in correspondence with the number of the slats being raised, so that it is necessary to apply a gradually larger raising force to the lowermost or uppermost slat as the opening degree or the closing degree increases. As a result, the operator who performs the manual traveling of the cord or the ball chain needs to apply a manual traveling force corresponding thereto to the cord or the ball chain and is made to feel such as a difficulty in performing the operation. In addition, it is difficult to perform a specific opening and closing operation of the opening portion by the plurality of slats through a specific manual operation of the cord or the ball chain by the operator, e.g., automatic opening and closing operation of the opening portion by the plurality of slats through an instantaneous manual operation of the cord or the ball chain by the operator.

Such a problem is not limited to the window blind apparatus and can also occur in a case where the cord or the ball chain is not used in a shutter apparatus which is provided with the cord or the ball chain or in a case where the lowermost slat is manually raised and lowered to open and close the opening portion in a shutter apparatus which is not provided with the cord or the ball chain.

The present invention has been devised in view of the above-described aspects, and its object is to provide an opening/closing apparatus for an opening portion which can be configured to be capable of overcoming the difficulty in manual operation by the operator, and which can also be configured to make it possible to perform a specific opening and closing operation with respect to the opening portion by the plurality of slats through a specific manual operation by the operator.

### Means for Solving the Problems

An opening/closing apparatus for an opening portion in accordance with the present invention comprises: a frame body which is disposed in an opening portion of a building; a plurality of slats which are juxtaposed to each other in a vertical direction in the opening portion surrounded by the frame body and which open and close the opening portion; a connecting mechanism for mutually connecting vertically adjacent ones of the plurality of slats; and a reaction force generating mechanism for generating a reaction force which increases in correspondence with a change in the number of the slats being raised in the opening portion and is oriented in an opposite direction to a direction of a load of the slats in the opening portion, wherein the raising of the slats in the opening portion is effected by at least the increasing reaction force generated by the reaction force generating mechanism.

According to the opening/closing apparatus for an opening portion in accordance with the present invention, since a reaction force generating mechanism is provided, and the raising of the slats in the opening portion is effected by at least the increasing reaction force generated by the reaction force generating mechanism, it is possible to assist the manual operating force of the operator by that reaction force. In consequence, it is possible to overcome the difficulty in manual operation by the operator; furthermore, by setting a rate of increase of the reaction force, as desired, it becomes possible to perform a specific opening and closing operation with respect to the opening portion by the plurality of slats through a specific manual operation by the operator.

For example, in both cases where the arrangement provided is such that the plurality of slats in the opening portion closed by the plurality of slats are raised, starting with a lowermost slat, and upper slats are consecutively overlapped on the lowermost slat to thereby open the opening portion, and where the arrangement provided is such that the plurality of slats in the opened opening portion are raised, starting with an uppermost slat, and lower slats are consecutively lifted by the uppermost slat to thereby close the opening portion, by providing an arrangement in which a rate of increase of a reaction force generated by such a reaction force generating mechanism is made equal to a rate of increase of the load of the slats being raised and members which are raised in association with the slats being raised, even if the number of the slats being raised in the opening and closing of the opening portion increases, it is possible to perform the opening and closing of the opening portion with a substantially constant manual operating force without enlarging a manual operating force of an operator, thereby making it possible to overcome the difficulty in manual operation by the operator. In addition, by providing an arrangement in which the rate of increase of the reaction force generated by the reaction force generating mechanism is made greater than the rate of increase of the load of the slats being raised and the members which are raised in association with the slats being raised, in the case where the arrangement provided is such that the plurality of slats in the opening portion closed by the plurality of slats are raised, starting with the lowermost slat, and upper slats are consecutively overlapped on the lowermost slat to thereby open the opening portion, when an instantaneous operating force is imparted to the lowermost slat from outside to open the opening portion in the closed state of the opening portion, the slats can be consecutively raised automatically, starting with the lowermost slat. Meanwhile, in the case where the arrangement provided is such that the plurality of slats in the opened opening portion are raised, starting with the uppermost slat, and lower slats are consecutively lifted by the uppermost slat to thereby close the opening portion, when an instantaneous operating force is imparted to the uppermost slat from outside to close the opening portion in the open state of the opening portion, the slats can be consecutively raised automatically, starting with the uppermost slat. In either case, it becomes possible to effect the opening and closing of the opening portion automatically despite the manual operation. Furthermore, in a case where the arrangement provided is such that the plurality of slats in the opening portion closed by the plurality of slats are simultaneously raised and the uppermost slat and the following lower slats are consecutively wound up owing to this raising to thereby open the opening portion, when an instantaneous operating force is imparted from outside to the plurality of slats closing the opening portion to open the opening portion in the closed state of the opening portion, the winding of the slats can be effected automatically. Thus, it becomes possible to perform a specific opening and closing operation with respect to the opening portion by the plurality of slats through a specific manual operation by the operator. It should be noted that, in the present invention, the reaction force of the reaction force generating mechanism may be generated from halfway in the raising of the slats.

In one example of the opening/closing apparatus for an opening portion in accordance with the present invention, the opening/closing apparatus for an opening portion further comprises a raising and lowering mechanism for raising and lowering the plurality of slats in the opening and closing of the opening portion, the reaction force generating mechanism is adapted to impart to the raising and lowering mechanism the reaction force which increases in correspondence with an increase of the load in the opening portion corresponding to an increase in the number of the slats being raised by the raising and lowering mechanism in the opening portion, and the raising and lowering mechanism is adapted to effect the raising of the slats in the opening portion by the reaction force imparted by at least the reaction force generating mechanism. In such a case, the raising and lowering mechanism may be adapted to effect the raising of the slats in the opening portion also by a raising force imparted from an outside in addition to the reaction force.

In a preferred example, the reaction force generating mechanism is adapted to impart to the raising and lowering mechanism the reaction force which decreases in correspondence with a decrease of the load of the slats in the opening portion corresponding to an decrease in the number of the slats being lowered by the raising and lowering mechanism in the opening portion. In such an example as well, by providing an arrangement similar to the one described above, the configuration makes it possible to overcome the difficulty in manual operation by the operator in the lowering of the slats, and makes it possible to perform a specific opening and closing operation with respect to the opening portion by the plurality of slats through a specific manual operation by the operator.

In the opening/closing apparatus for an opening portion in accordance with the present invention, the raising and lowering mechanism may include a flexible elongated member, a traveling mechanism for causing the elongated member to travel, and a transmitting mechanism for transmitting the traveling of the elongated member to the slats, in which case the traveling mechanism includes a rotating body around which the elongated member is wound and which causes the elongated member to travel as the rotating body rotates and a rotational force imparting mechanism for imparting a rotational force to the rotating body to rotate the rotating body, and the transmitting mechanism connects to a slat one end of one suspended portion of the elongated member suspended from the rotating body, so as to transmit the traveling of the elongated member to the slats, wherein the reaction force generating mechanism includes a flexible elongated weight connected at one end thereof to another suspended portion, suspended from the rotating body, of the elongated member wound around the rotating body, and a supporting member for accommodating a moving portion of the weight which moved as the other suspended portion of the elongated member suspended from the rotating body travels in an upward direction, so as to support that moving portion. Further, the moving portion of the weight supported on the supporting member may be adapted to be drawn out from the supporting member as the other suspended portion of the elongated member suspended from the rotating body travels in a downward direction, so as to allow the support thereof on the supporting member to be gradually released, and the reaction force generating mechanism may be adapted to allow a load of a drawn-out portion of the weight being drawn out from the supporting member to be imparted to the raising and lowering mechanism as the reaction force.

In addition, in the opening/closing apparatus for an opening portion in accordance with the present invention, the raising and lowering mechanism may include a flexible elongated member, a traveling mechanism for causing the elongated member to travel, and a transmitting mechanism for transmitting the traveling of the elongated member to the lowermost slat, in which case the traveling mechanism includes a first rotating body around which the elongated member is wound, a rotating mechanism for rotating the first rotating body, and a rotational force imparting mechanism for imparting a rotational force to the rotation mechanism, and the transmitting mechanism connecting to a slat one end of one suspended portion of the elongated member suspended from the first rotating body, so as to transmit the traveling of the elongated member to the slats. Further, the reaction force generating mechanism includes a second rotating body and a flexible elongated weight wound around the second rotating body, one end of one suspended portion, suspended from the second rotating body, of the weight wound around the second rotating body being connected to one end of another suspended portion, suspended from the first rotating body, of the elongated member wound around the first rotating body, one end of another suspended portion, suspended from the second rotating body, of the weight wound around the second rotating body being formed as a free end. Furthermore, the reaction force generating mechanism may be adapted to allow a difference between a load of the one suspended portion, suspended from the second rotating body, of the weight wound around the second rotating body and a load of the other suspended portion, suspended from the second rotating body, of the weight wound around the second rotating body to be imparted to the raising and lowering mechanism as the reaction force.

In the present invention, the flexible elongated weight may be constituted by, for example, a plurality of weight elements which are connected to each other and are capable of generating a reaction force which increases or decreases in correspondence with an increase or decrease of the load of the slats corresponding to the number of the slats being raised or lowered. Preferably, the weight is constituted by a no-back chain having chain elements as the weight elements. Such weight elements may have a mutually identical mass, but may have mutually different masses, and in a case where a plurality of weight elements having such mutually different masses are used, weight elements whose masses consecutively increase from one end to the other end may be arrayed in a row of weight elements constituted by a plurality of mutually connected weight elements.

In the present invention, a vertically lowermost slat among the plurality of slats in the opening portion may be adapted to be precedingly raised to open the opening portion, and the lowermost slat is adapted to be precedingly lowered to close the opening portion. Alternatively, a vertically uppermost slat among the plurality of slats in the opening portion may be adapted to be precedingly raised to close the opening, and the uppermost slat may be adapted to be precedingly lowered to open the opening portion.

In another example of the present invention, the plurality of slats in the opening portion are adapted to be simultaneously raised or lowered to open or close the opening portion. In such an example, the opening/closing apparatus for an opening portion may further comprise a rotatable winding member. In the example in which the winding member is provided, when the opening portion is closed, the plurality of slats in the opening portion may be adapted to be consecutively wound up around the winding member, starting with an uppermost slat, whereas when the opening portion is opened, the slats wound up around the winding member may be adapted to be paid out, and the reaction force generating mechanism may be adapted to generate a reaction force which increases in correspondence with the number of the slats which are wound up around the winding member.

In the example of the opening/closing apparatus for an opening portion in accordance with the present invention in which the plurality of slats in the opening portion are adapted to be simultaneously raised or lowered to open or close the opening portion, the reaction force generating mechanism may include a flexible elongated weight capable of traveling; a rotatable rotating body around which the weight is wound, so as to allow the rotating body to be rotated as the weight travels; and a connecting mechanism which connects a slat in the opening portion to one suspended portion of the weight suspended from the rotating body, so as to transmit the raising of the slats in the opening portion to the one suspended portion. In this case, the connecting mechanism may be adapted to connect the one end of the suspended portion to a lowermost slat among the plurality of slats in the opening portion, and, in a state in which the opening portion is completely closed, another suspended portion of the weight suspended from the rotating body may have a mass which is equivalent to or greater than a mass (weight) of the one suspended portion of the weight suspended from the rotating body. Still further, one end of the other suspended portion of the weight suspended from the weight may be formed as a free end.

The opening/closing apparatus for an opening portion in accordance with the present invention is a shutter apparatus or a window blind apparatus, and in the case of the shutter apparatus, it may be disposed in an opening portion of a building such as an entrance, while in the case of the window blind apparatus, it may be disposed in an opening portion of a building such as a window.

### Advantages of the Invention

According to the invention, it is possible to provide an opening/closing apparatus for an opening portion which can be configured to be capable of overcoming the difficulty in manual operation by the operator, and which can also be configured to make it possible to perform a specific opening and closing operation of the opening portion by the plurality of slats through a specific manual operation by the operator.

### BRIEF DESCRIPTION OF THE DRAWINGS

FIG. 1 is an explanatory perspective view of a preferred embodiment of the invention;

FIG. 2 is an explanatory partial cross-sectional side view of the embodiment shown in FIG. 1;

FIG. 3 is an explanatory cross-sectional plan view of a portion shown in FIG. 1;

FIG. 4 is an explanatory partial cross-sectional front view of the embodiment shown in FIG. 1;

FIG. 5 is an explanatory partial enlarged perspective view of the embodiment shown in FIG. 1;

FIG. 6 is an explanatory partial enlarged cross-sectional side view of the embodiment shown in FIG. 1;

FIG. 7 is an explanatory partial enlarged cross-sectional side view of the embodiment shown in FIG. 1;

FIG. 8 is an explanatory diagram of a tilting mechanism and a suspending mechanism of the embodiment shown in FIG. 1;

FIG. 9 is an explanatory partial enlarged cross-sectional side view of the embodiment shown in FIG. 1;

FIG. 10 is an explanatory partial enlarged cross-sectional side view of the embodiment shown in FIG. 1;

FIG. 11 is an explanatory partial enlarged cross-sectional front view of the embodiment shown in FIG. 1;

FIG. 12 is an explanatory partial fragmentary perspective view of the embodiment shown in FIG. 1;

FIG. 13 is an explanatory partial enlarged side view of a raising and lowering mechanism of the embodiment shown in FIG. 1;

FIG. 14 is an explanatory partial enlarged side view of the raising and lowering mechanism of the embodiment shown in FIG. 1;

FIG. 15 is an explanatory partial enlarged front view of the raising and lowering mechanism of the embodiment shown in FIG. 1;

FIG. 16 is a partial diagram explaining the operation of the raising and lowering mechanism of the embodiment shown in FIG. 1;

FIG. 17 is a diagram explaining the operation of the tilting mechanism shown in FIG. 8;

FIG. 18 is a diagram explaining the operation of the tilting mechanism shown in FIG. 8;

FIG. 19 is a diagram explaining the operation of the tilting mechanism shown in FIG. 8;

FIG. 20 is a diagram explaining the operation of the raising and lowering mechanism of the embodiment shown in FIG. 1;

FIG. 21 is a diagram explaining the operation of the embodiment shown in FIG. 1;

FIG. 22 is a diagram explaining the operation of the embodiment shown in FIG. 1;

FIG. 23 is an explanatory view of another preferred embodiment of the invention; and

FIG. 24 is an explanatory view of still another preferred embodiment of the invention.

### MODE FOR CARRYING OUT THE INVENTION

Next, a more detailed description will be given of the mode for carrying out the invention on the basis of the preferred embodiments illustrated in the drawings. It should be noted that the present invention is not limited to these embodiments.

### EMBODIMENTS

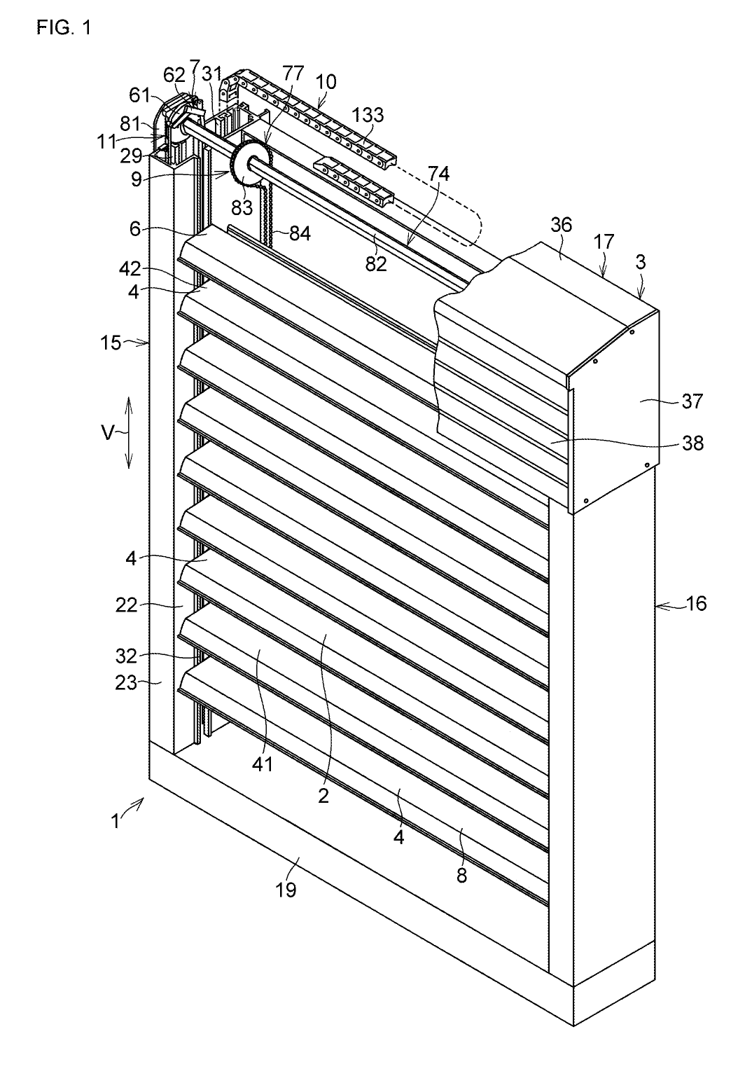

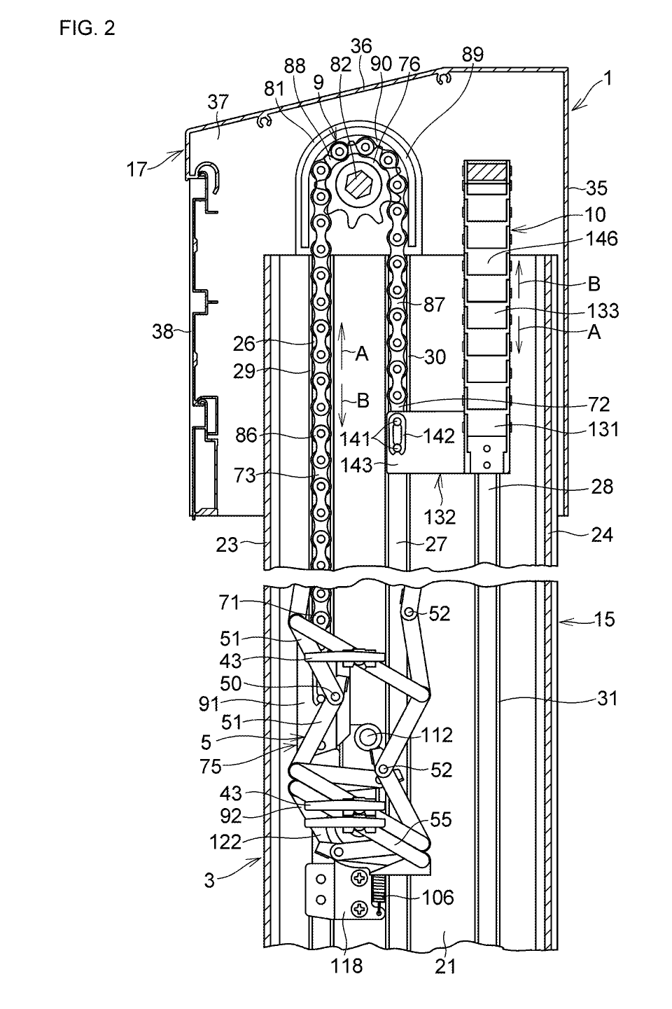

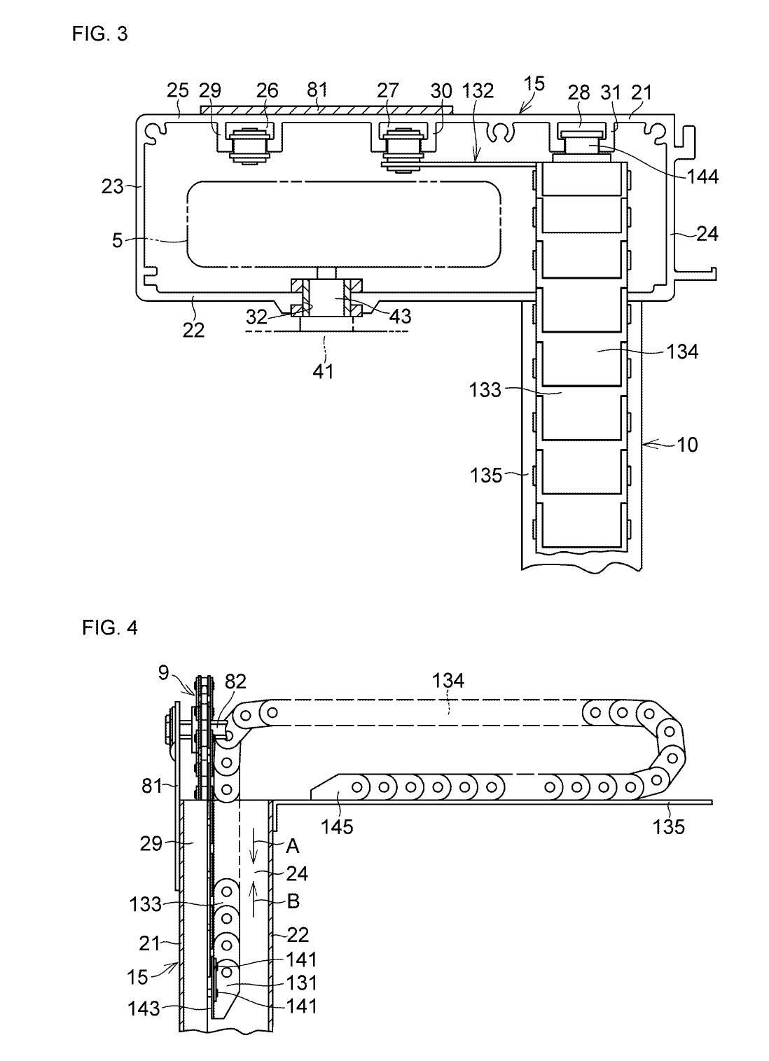

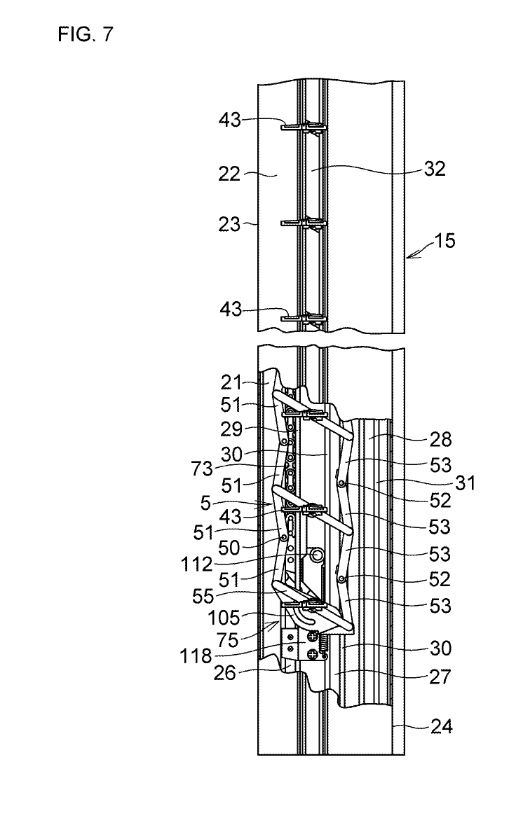

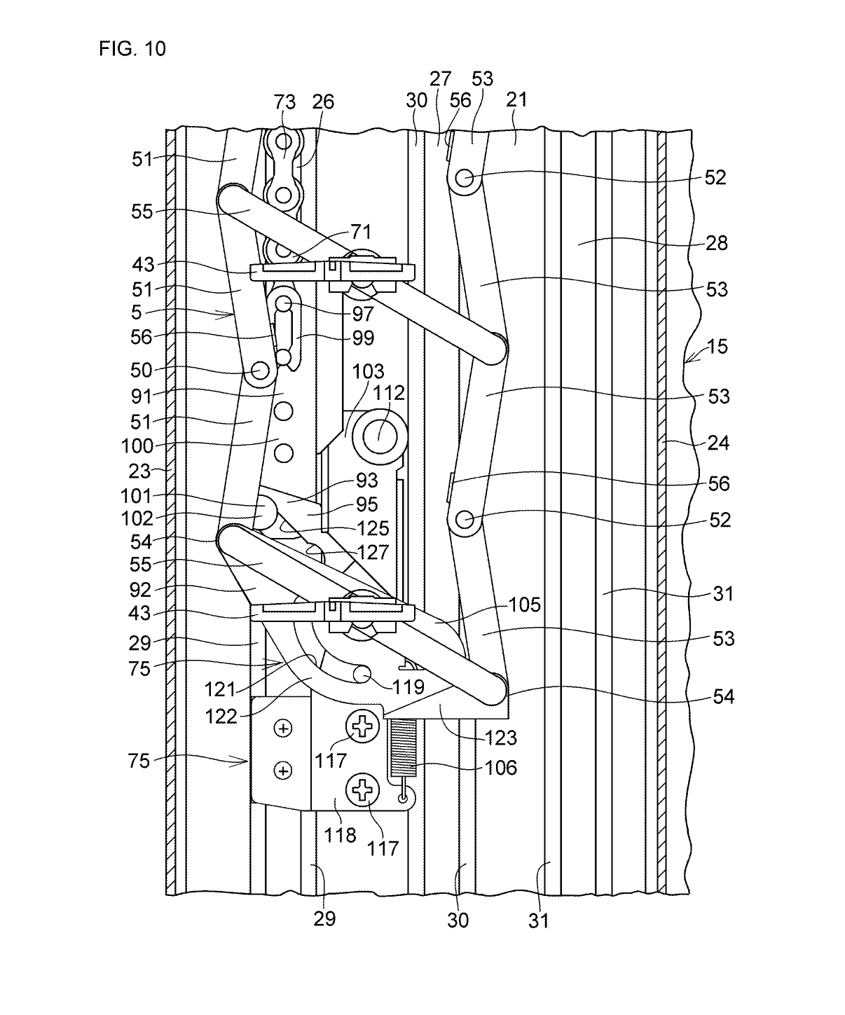

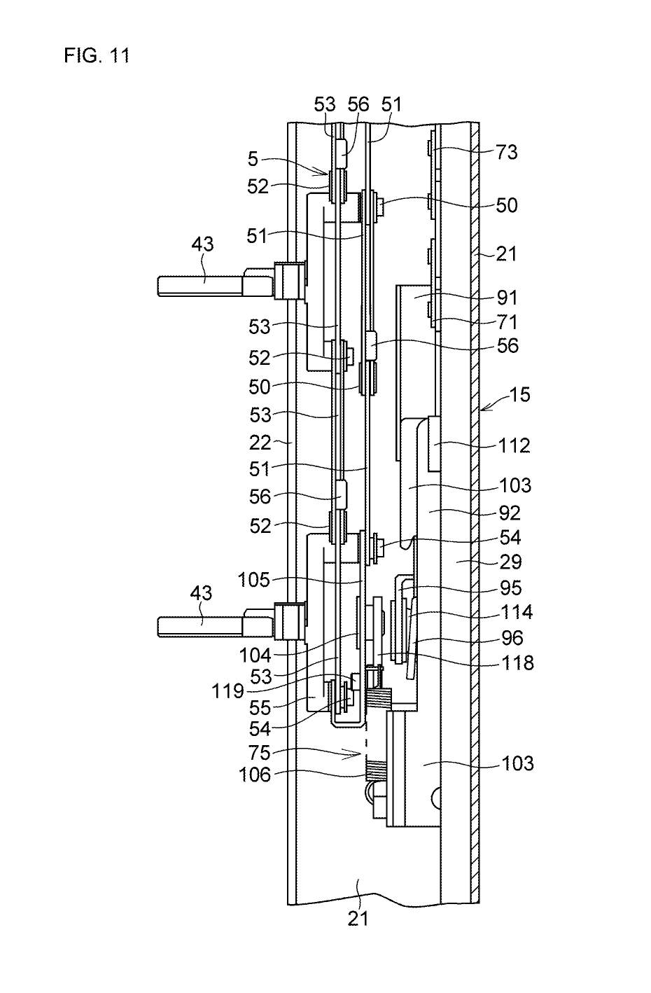

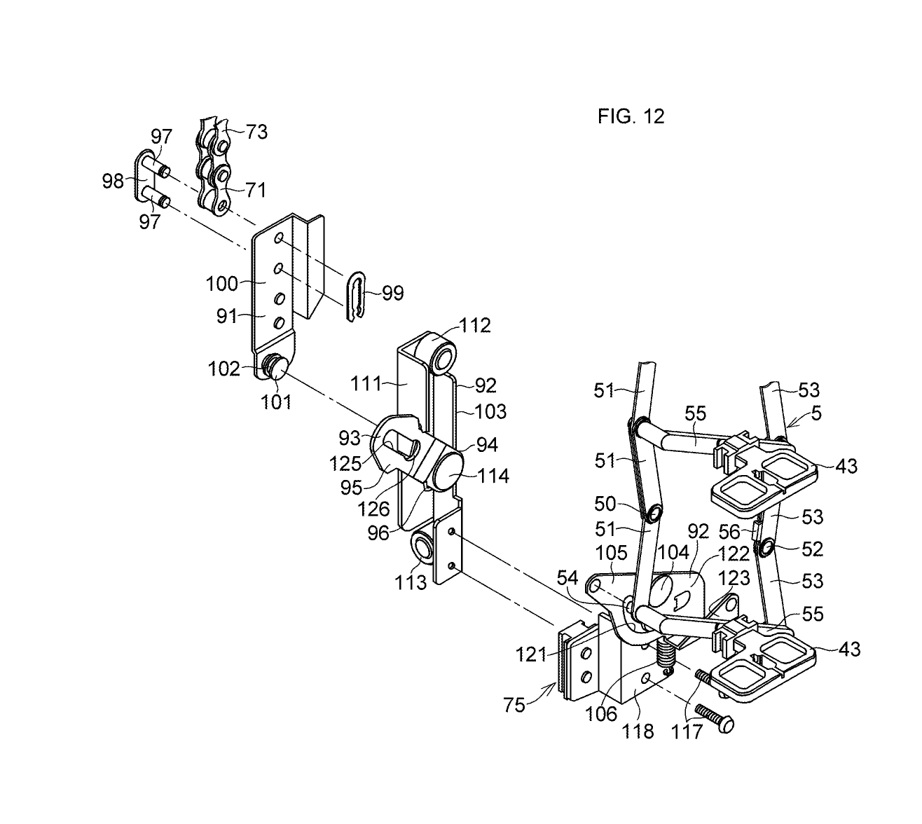

In FIGS. 1 to 15, a window blind apparatus 1 in accordance with this embodiment is comprised of a frame body 3 which is disposed in an opening portion 2 of a building such as a window; a plurality of slats 4 which are juxtaposed to each other in a vertical direction V in the opening portion 2 surrounded by the frame body 3 and which opens and closes the opening portion 2; a link mechanism 5 serving as a connecting mechanism for mutually connecting the slats 4 adjacent to each other in the vertical direction V among the plurality of slats 4; a raising and lowering mechanism 9 which has a suspending mechanism 7 for suspending from the frame body 3 an uppermost slat 6 among the plurality of slats 4 connected by the link mechanism 5, and which raises and lowers the plurality of slats 4 in opening and closing the opening portion 2, by raising the slats 4, starting with a lowermost slat 8 among the plurality of slats 4, and by lowering the slats 4, starting with that lowermost slat 8, so as to open and close the opening portion 2 by the plurality of slats 4 connected by the link mechanism 5; a reaction force generating mechanism 10 for imparting to the raising and lowering mechanism 9 a reaction force which is oriented in a direction opposite to the direction of the load of the slats 4 in the opening portion 2 and which increases or decreases in correspondence with an increase or decrease of the load of the slats 4 in the opening portion 2 corresponding to the number of the slats 4 being raised or lowered by the raising and lowering mechanism 9 in the opening portion 2; and a tilting mechanism 11 for tilting the plurality of slats 4 in the raising and lowering of the plurality of slats 4 by the raising and lowering mechanism 9.

The frame body 3 includes a pair of vertical frames 15 and 16 juxtaposed to each other, an upper frame 17 disposed in such a manner as to bridge upper portions of the vertical frames 15 and 16, and a lower frame 19 disposed in such a manner as to bridge lower portions of the vertical frames 15 and 16.

The vertical frame 15, which is formed in the same way as the vertical frame 16, is integrally formed by including an outer side wall portion 21, an inner side wall portion 22 disposed in face-to-face relation to the outer side wall portion 21, and a front wall portion 23 and a rear wall portion 24 disposed in such a manner as to bridge the outer side wall portion 21 and the inner side wall portion 22 and oppose each other. The outer side wall portion 21 has a side wall plate portion 25 and three pairs of holding wall portions 29, 30, and 31 which are formed integrally with the side wall plate portion 25 and define three holding grooves 26, 27, and 28 extending in the vertical direction V. The inner side wall portion 22 has a slit 32 extending in the vertical direction V.

The upper fame 17 includes a roof portion 36 integrally having a rear plate portion 35, a pair of side plate portions 37 attached to the roof portion 36 and the respective outer side wall portions 21 of the vertical frames 15 and 16, and a latticed front wall portion 38 suspended from a front portion of the roof portion 36 in such a manner as to bridge the pair of side plate portions 37 below the roof portion 36.

Each of the slats 4 includes a slat body 41 and an attachment 43 for attaching one longitudinal end portion 42 of the slat body 41 to the link mechanism 5. Each attachment 43 is fixed at one end to the end portion 42 of the corresponding slat body 41 through a fastener 44, and projects at the other end through the slit 32 into the vertical frame 15.

The link mechanism 5 includes a plurality of front edge link members 51 which are rotatably connected to each other through shaft members 50 and are foldable; a plurality of rear edge link members 53 which are rotatably connected to each other through shaft members 52 and are foldable; uppermost and lowermost transverse members 55 which are rotatably connected to upper end portions of the uppermost front edge link member 51 and rear edge link member 53 and to lower end portions of the lowermost front edge link member 51 and rear edge link member 53, respectively, through shaft members 54; transverse members 55 which are respectively rotatably connected to every other shaft member 50 and 52 on the front edge link member 51 side and the rear edge link member 53 side, to a substantially central portion of which the other end of a corresponding attachment 43 projecting into the vertical frame 15 through the slit 32 is secured; and bent portions 56 which are integrally formed on respective ones of every other front edge link member 51 and rear edge link member 53 so as to determine respective folding directions of the plurality of front edge link members 51 and the rear edge link members 53 which are respectively rotatably connected to each other through the shaft members 50 and 52.

In the raising of the lowermost front edge link member 51, adjacent ones of the front edge link members 51 which are rotatably connected to each other by the shaft members 50 with the transverse members 55 not connected thereto are adapted to be folded by being restricted by the bent portions 56 such that the shaft members 50 are directed toward the rear wall portion 24. Similarly, in the raising of the lowermost rear edge link member 53, adjacent ones of the rear edge link members 53 which are rotatably connected to each other by the shaft members 52 with the transverse members 55 not connected thereto are adapted to be folded by being restricted by the bent portions 56 such that the shaft members 52 are directed toward the front wall portion 23. The folded front edge link members 51 and rear edge link members 53 are adapted to be alternately positioned in the vertical direction V.

The suspending mechanism 7 includes a suspending plate 62 secured to a swingable member 61 of the tilting mechanism 11 in an upper portion of the vertical frame 15; a flexible cord-like member 66, such as a wire, a rope, or a belt, which is rotatably connected at one end to a shaft member 64 at a distal end portion of one arm portion 63 of the suspending plate 62, and is rotatably connected at the other end to the shaft member 54 at an upper end portion of the uppermost front edge link member 51, which serves as one end portion 65 of the uppermost link mechanism 5; and a flexible cord-like member 70, such as a wire, a rope, or a belt, which is rotatably connected at one end to a shaft member 68 at a distal end portion of the other arm portion 67 of the suspending plate 62, and is rotatably connected at the other end to the shaft member 54 at an upper end portion of the uppermost rear edge link member 53, which serves as the other end portion 69 of the uppermost link mechanism 5. The swingable member 61 is swingably (rotatably) attached to a rotating shaft 82 of the raising and lowering mechanism 9, and the rotating shaft 82 is rotatably supported at both ends by a pair of bearing plates 81 respectively mounted on the outer side wall portions 21 of the vertical frames 15 and 16. Thus, the suspending mechanism 7 is adapted to allow the uppermost slat 6 among the plurality of slats 4 connected by the link mechanism 5 to be suspended from the frame body 3 through the cord-like members 66 and 70, the swingable member 61, the rotating shaft 82, and the bearing plates 81.

The raising and lowering mechanism 9 includes an ended chain 73 serving as a flexible elongated member which has ends 71 and 72 on both sides and is held in an undeflected manner; a traveling mechanism 74 for causing the chain 73 to travel in one direction A and the other direction B which is an opposite direction to the one direction A; and a transmitting mechanism 75 for transmitting the traveling of the one end 71 of the chain 73 in the directions A and B to the lowermost slat 8.

The traveling mechanism 74 includes a sprocket wheel 76 serving as a rotating body around which the chain 73 is wound and which causes the chain 73 to travel as the sprocket wheel 76 rotates, and a rotational force imparting mechanism 77 for imparting a rotational force to the sprocket wheel 76 to rotate the sprocket wheel 76.

The traveling mechanism 74 is adapted to cause the chain 73 to travel in the directions A and B by the rotation of the sprocket wheel 76 due to the rotational force imparted thereto.

The rotational force imparting mechanism 77 includes the rotating shaft 82 which is rotatably supported at both ends by the pair of bearing plates 81 respectively mounted on the outer side wall portions 21 of the vertical frames 15 and 16, and to which the sprocket wheel 76 is secured; a wheel 83 for a ball chain which is secured to the rotating shaft 82 on the vertical frame 15 side; an endless ball chain 84 which is wound around the wheel 83, is suspended on the indoor side of the building, and can be manually caused to travel; and an unillustrated known ratchet mechanism for temporarily inhibiting the traveling of the ball chain 84 by the manual operation of the ball chain 84.

The rotational force imparting mechanism 77 is adapted to cause the rotating shaft 82 mounted rotatably on the respective outer side wall portions 21 of the vertical frames 15 and 16 via the bearing plates 81 to rotate by the imparting of the rotational force to the wheel 83 due to the traveling of the ball chain 84 by the manual operation of the ball chain 84, to thereby impart the rotational force to the sprocket wheel 76 by the rotation of the rotating shaft 82.

The chain 73 at one suspended portion 86 thereof suspended from the sprocket wheel 76 and having the one end 71 is partially disposed in the holding groove 26 movably in the directions A and B, while the chain 73 at the other suspended portion 87 thereof suspended from the sprocket wheel 76 and having the one end 72 is partially disposed in the holding groove 27 movably in the directions A and B. The chain 73 at a wound-around portion 88 thereof wound around the sprocket wheel 76 is disposed movably in the directions A and B in a holding passage 90 between the sprocket wheel 76 and a holding member 89 mounted on the bearing plate 81. The deflection of the chain 73 is prevented by the holding wall portions 29 and 30 and the holding member 89 respectively forming the holding grooves 26 and 27 and the holding passage 90. Thus, the chain 73 is held in an undeflected state by the holding wall portions 29 and 30 and the holding member 89.

The transmitting mechanism 75 includes a traveling member 91 connected to the one end 71 of the chain 73 so as to travel in the directions A and B by the traveling of the chain 73 in the same directions A and B; a movable body 92 which is connected to the lowermost slat 8 by means of the lowermost transverse member 55 and the attachment 43, and which is movable in the directions A and B; a rotating arm member 95 having one end 93 rotatably and linearly movably connected to the traveling member 91 and the other end 94 rotatably connected to the movable body 92, so as to undergo rotation in an R1 direction which allows the lowering of the traveling member 91 with respect to the movable body 92; and a torsion spring 96 serving as a resiliency imparting member for imparting to the rotating arm member 95 a resilient rotational force in an R2 direction resisting the rotation of the rotating arm member 95 in the R1 direction, so as to stop the lowering of the traveling member 91 with respect to the movable body 92.

The traveling member 91 includes a main body portion 100 which is disposed in the holding groove 26 and fitted to the pair of holding wall portions 29, and which is connected at an upper end portion thereof to the one end 71 of the chain 73 by means of a retainer 99 and a connector 98 having a pair of connecting pins 97, so as to be movable in the directions A and B in the same way as the chain 73; and a pin 102 secured to a lower end portion of the main body portion 100 and having an enlarged head portion 101.

The movable body 92 includes a linearly movable member 103 which is supported by the frame body 3 linearly movably in the directions A and B, and to which the other end 94 of the rotating arm member 95 is rotatably connected; a swingable member 105 connected to the lowermost slat 8 through the transverse member 55 and connected to the linearly movable member 103 through a shaft member 104 swingably in an R3 direction and an R4 direction; and a coil spring 106 serving as a resilient body and having one end connected to the linearly movable member 103 and the other end connected to the swingable member 105.

The linearly movable member 103 includes a main body 111 disposed between the holding wall portions 29 and 30 and extending in the vertical direction V; a rolling roller 112 which is fitted to an upper portion of the main body 111 and is rollably brought into contact with the pair of holding wall portions 30; a rolling roller 113 which is fitted to a lower portion of the main body 111 and is rollably brought into contact with the side wall plate portion 25; a pin 114 which is provided on the main body 111 between the rolling rollers 112 and 113, and to which the other end 94 of the rotating arm member 95 is rotatably fitted; a contact portion 115 formed on the main body 111 above the rotating arm member 95 so as to restrict by contact the rotation of the rotating arm member 95 in the R2 direction by more than a predetermined amount; a support 118 secured to a lower portion of the main body 111 through screws 117 and adapted to swingably support the swingable member 105; and a contact portion 116 formed on the support 118 below the rotating arm member 95 so as to restrict by contact the rotation of the rotating arm member 95 in the R1 direction by more than a predetermined amount. The support 118 is provided with the shaft member 104 and a pin 119 which is disposed in a slit 121.

The swingable member 105 includes a main body portion 122 which has the slit 121 of a circular arc shape with an end portion of the pin 119 disposed therein and to which the other end of the coil spring 106 is connected, as well as a turned-back portion 123 which is integrally formed with the main body portion 122 and is turned back.

The swingable member 105 is swingably attached at the main body portion 122 thereof to the support 118 of the linearly movable member 103 through the shaft member 104. The swingable member 105 is rotatably connected at one end of the main body portion 122 to a lower end portion of the lowermost front edge link member 51 and to one end portion of the lowermost transverse member 55 through the shaft member 54. The swingable member 105 is rotatably connected at one end of the turned-back portion 123 to a lower end portion of the lowermost rear edge link member 53 and to the other end portion of the lowermost transverse member 55 through the shaft member 54.

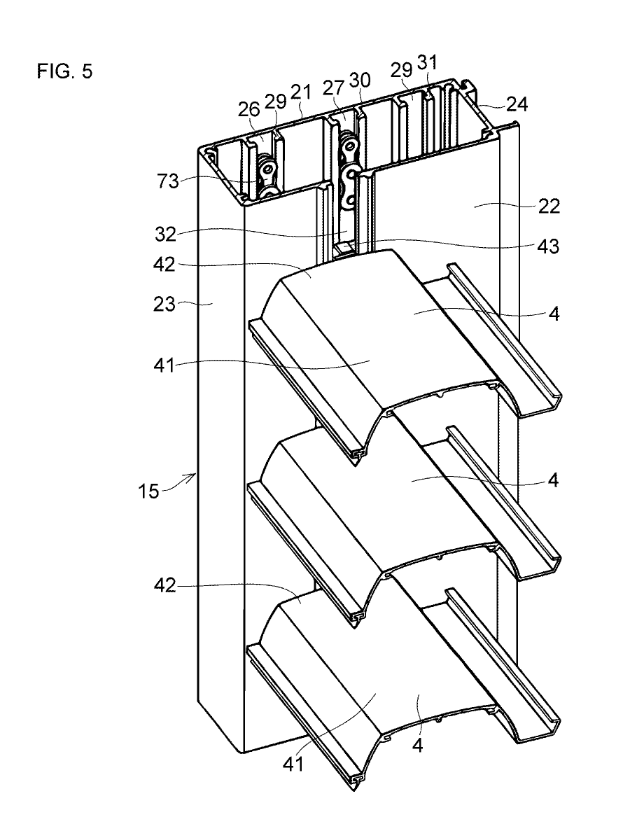

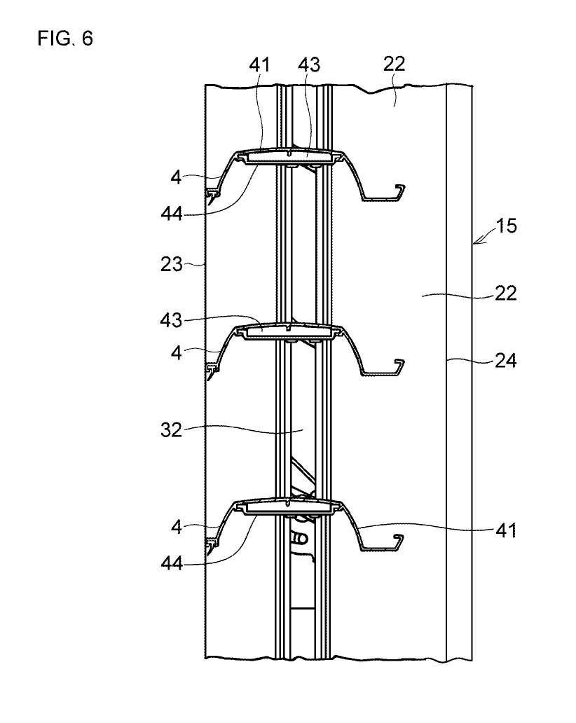

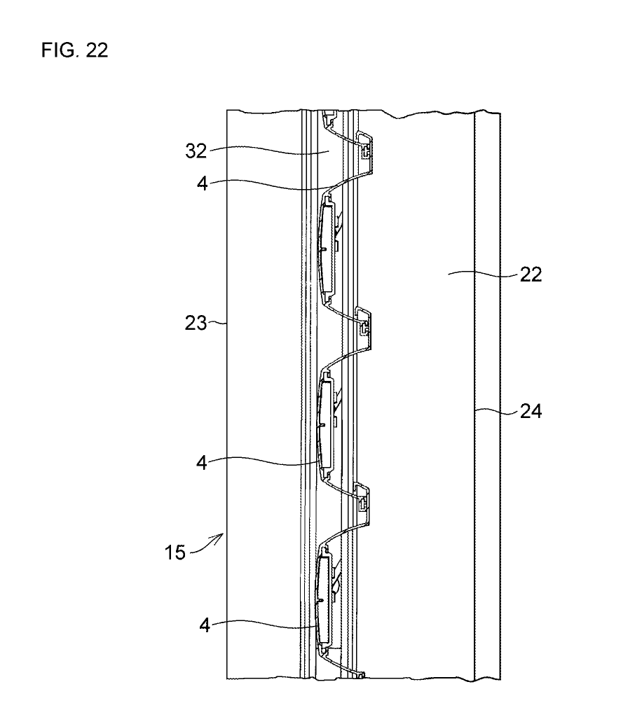

The coil spring 106 resiliently pulls the swingable member 105 to rotate the swingable member 105 about the shaft member 104 secured to the support 118, such that the swingable member 105 is set in an initial swinging position, i.e., in a position where the slat 4 is rotated in the R3 direction to a horizontal state, as shown in FIGS. 5 and 6, without being rotated in the R4 direction to a vertical state, as shown in FIG. 22. The swinging motion (rotation) of the swingable member 105 about the shaft member 104 is adapted to be guided by the movement of the pin 119 along the slit 121, and the range of the swinging motion (rotation) of the swingable member 105 is restricted by both ends of the slit 121.

An elongated hole 125, in which the pin 102 is fitted rotatably and linearly movably along the longitudinal direction of the rotating arm member 95, is formed in the one wide end 93 of the rotating arm member 95. An enlarged hole portion 127, into and from which the enlarged head portion 101 of the pin 102 can be inserted and withdrawn, is formed in an end portion 126 of the elongated hole 125 located on the other end 94 side of the rotating arm member 95. The other end 94 of the rotating arm member 95 is connected to the pin 114 rotatably in the R1 direction and the R2 direction.

The rotating arm member 95 is disposed on the linearly movable member 103 such that, in the rotation of the rotating arm member 95 in the R1 direction, the pin 102 of the traveling member 91 moves through the elongated hole 125 from the one end 93 side toward the other end 94 side of the rotating arm member 95 to an extent of not reaching the enlarged hole portion 127, while, in the rotation of the rotating arm member 95 in the R2 direction, the pin 102 of the traveling member 91 moves through the elongated hole 125 from the other end 94 side toward the one end 93 side of the rotating arm member 95.

The torsion spring 96 wound around the pin 114 is retained at one end thereof to the rotating arm member 95 and at the other end thereof to the linearly movable member 103. The torsion spring 96 is disposed so as to impart to the rotating arm member 95 a resilient rotational force in the R2 direction resisting the rotation of the rotating arm member 95 in the R1 direction.

The transmitting mechanism 75 may be provided with a stopper (not shown) which is attached to the frame body 3 so as to be brought into contact with a lower portion of the linearly movable member 103 in the closed state of the opening portion 2.

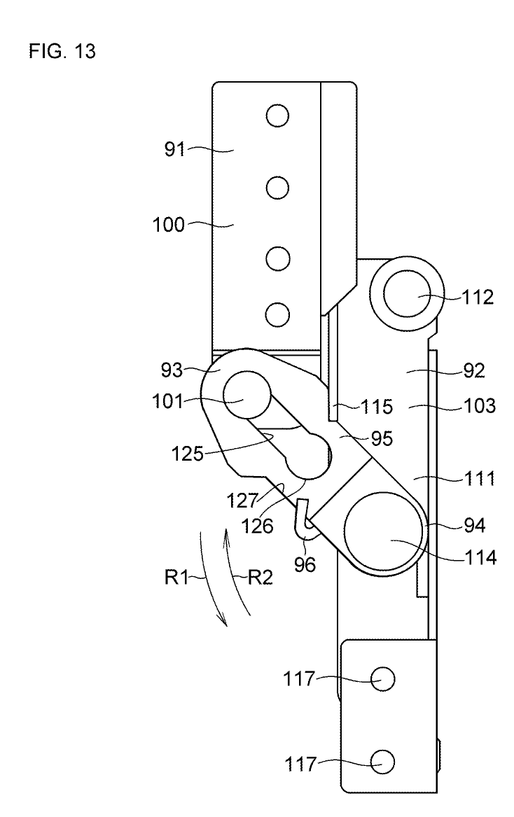

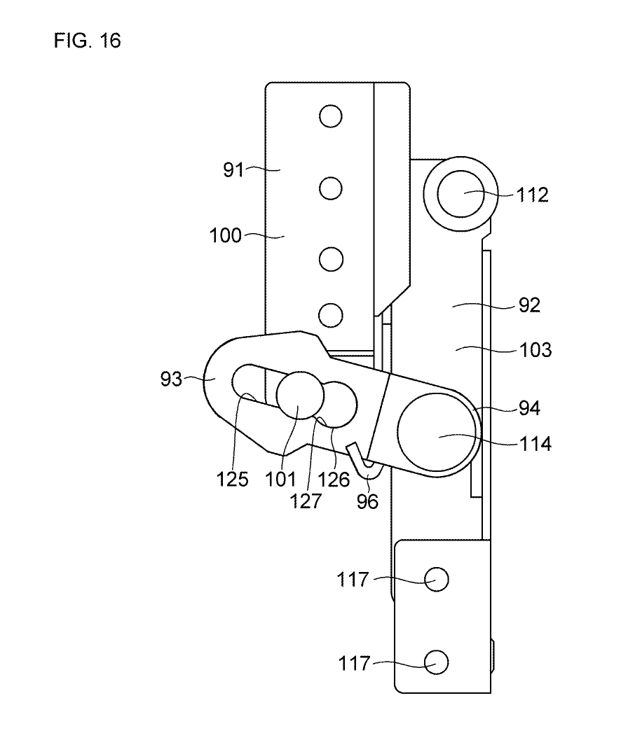

In the transmitting mechanism 75 for connecting to the lowermost slat 8 the end 71 of the one suspended portion 86, suspended from the sprocket wheel 76, of the chain 73 serving as the elongated member wound around the sprocket wheel 76 serving as the rotating body, when, in the lowering of the lowermost slat 8 due to the traveling of the chain 73 in the direction B, the lowermost slat 8 has collided against a foreign object, e.g., a person, and the collision has made it impossible for the lowermost slat 8 to be lowered, the traveling member 91 is lowered relative to the movable body 92. At the time of this lowering, the rotating arm member 95 rotates in the R1 direction from the position shown in FIG. 13 to the position shown in FIG. 16 against the resiliency of the torsion spring 96. Hence, the lowering of the traveling member 91 relative to the movable body 92 is stopped by the resilient rotational force of the torsion spring 96 in the R2 direction which gradually increases. Therefore, in the event that an abnormality has occurred in which the lowering of the lowermost slat 8 is hampered, the transmitting mechanism 75 is adapted to resiliently prevent the lowering of the lowermost slat 8 by the rotation of the rotating arm member 95 against the resiliency of the torsion spring 96 owing to the relative displacement of the movable body 92 in the vertical direction V relative to the traveling member 91. When a rotation in the R1 direction by more than a predetermined amount has occurred to the rotating arm member 95, the contact portion 116 is adapted to be brought into contact with the rotating arm member 95 to forcibly stop that rotation, thereby forcibly stopping the lowering of the traveling member 91 relative to the movable body 92. In addition, even if the operation of the chain 73 is not stopped immediately and the chain 73 is caused to travel slightly further in the downward direction A although the opening portion 2 is completely closed and the aforementioned stopper has been brought into contact with the lower portion of the linearly movable member 103, the rotating arm member 95 is adapted to be stopped while rotating in the same way as described above. In other words, the rotating arm member 95 itself, which is rotatably and linearly movably connected to the one end 71 of the chain 73 through the traveling member 91, is adapted to rotate about the pin 114 against the resiliency of the torsion spring 96 and to linearly move relative to the traveling member 91 so as not to cause further downward movement of the movable body 92. Therefore, disadvantages cease to occur such as those in which the wholly extended link mechanism 5 is further extended and the slats 4 set in the completely closed state are further tilted, thereby making it possible to avoid causing damage to the link mechanism 5 and the slats 4.

In the state in which the transmitting mechanism 75 is disposed inside the frame body 3, the enlarged head portion 101 of the pin 102 is not disposed in the enlarged hole portion 127 of the elongated hole 125, so that the rotating arm member 95 does not come off the traveling member 91 unintentionally. In the state in which the traveling member 91 and the movable body 92 of the transmitting mechanism 75 are removed from within the frame body 3, mutual positions of the traveling member 91 and the movable body 92 can be altered freely, so that the enlarged head portion 101 of the pin 102 can be easily inserted into and withdrawn from the enlarged hole portion 127 of the elongated hole 125.

The raising and lowering mechanism 9 is adapted to raise and lower the lowermost slat 8 among the plurality of slats 4 through the transmitting mechanism 75 owing to the traveling of the chain 73 in the directions A and B by the rotation of the sprocket wheel 76 through the wheel 83 and the rotating shaft 82 due to the manual operation of the ball chain 84, to thereby effect the raising and lowering, starting with the lowermost slat 8 among the plurality of slats 4. In the raising and lowering mechanism 9, the load in the direction B of the slats 4, the front edge link members 51, the rear edge link members 53, the transverse members 55, and the chain 73, which increases or decreases according to the number of the slats 4 to be raised or lowered, the numbers of the front edge link members 51 and the rear edge link members 53 which are thereby folded and the transverse members 55 associated therewith, and the difference in length between the suspended portion 86 and the suspended portion 87 of the chain 73 which is made to travel, is applied to the one end 71 of the suspended portion 86 of the chain 73.

The reaction force generating mechanism 10 includes a no-back chain 133 which serves as a flexible elongated weight and is connected at one end 131 through a connecting mechanism 132 to the one end 72 of the other suspended portion 87, suspended from the sprocket wheel 76, of the chain 73 wound around the sprocket wheel 76; and a supporting plate 135 serving as a supporting member for accommodating a moving portion 134 of the no-back chain 133 which moved in the direction B as the other suspended portion 87 of the chain 73 suspended from the sprocket wheel 76 travels in the same direction B, so as to support that moving portion 134.

The connecting mechanism 132 includes a connecting plate 143 which is mounted by means of a pair of shaft pins 141, i.e., chain elements, disposed at the one end 72 of the chain 73 and by means of a retainer 142 for the shaft pins 141; and a bobbin-like piece member 144 which is rotatably mounted on the connecting plate 143 and is disposed in the holding groove 28 movably in the directions A and B. Chain elements at the one end 131 of the no-back chain 133 are secured to the connecting plate 143.

The no-back chain 133 consists of a row of chain elements in which chain elements serving as a plurality of weight elements having a mutually identical mass are rotatably connected to each other in series so as to be capable of being deflected (bent) only in one direction. The load of the chain elements of the no-back chain 133 is set to correspond to a total load combining the load of the slats 4, the load of the front edge link members 51 and the rear edge link members 53, and the load of the transverse members 55 associated therewith, which increases each time the chain elements are accommodated on the supporting plate 135 or drawn out from the supporting plate 135, but load of the chain elements of the no-back chain 133 may be set by incorporating thereinto the load of the chain 73 corresponding to a difference in length between the suspended portion 86 and the suspended portion 87 of the chain 73 which increases or decreases.

The supporting plate 135 is secured at end portions thereof to the respective upper portions of the vertical frames 15 and 16 in such a manner to bridge those upper portions, and the chain elements at the other end 145 of the no-back chain 133, which is adapted to be bendable only to one side, are secured to the supporting plate 135. As the suspended portion 87 of the chain 73 suspended from the sprocket wheel 76 travels in the direction A, i.e., the downward direction, the moving portion 134 of the no-back chain 133 supported on the supporting plate 135 is adapted to be drawn out from the supporting plate 135, so as to allow the support thereof on the supporting plate 135 to be gradually released. Thus, the reaction force generating mechanism 10 is adapted to allow the load in the direction A of a drawn-out portion 146 of the no-back chain 133 being drawn out from the supporting plate 135 to be imparted to the one end 72 of the chain 73 through the connecting mechanism 132 as a reaction force, acting in the direction A opposite to the direction B, to the load applied in the direction B to the one end 71 of the chain 73, i.e., the load transmitted in the direction B to the one end 72 of the chain 73 through the chain 73.

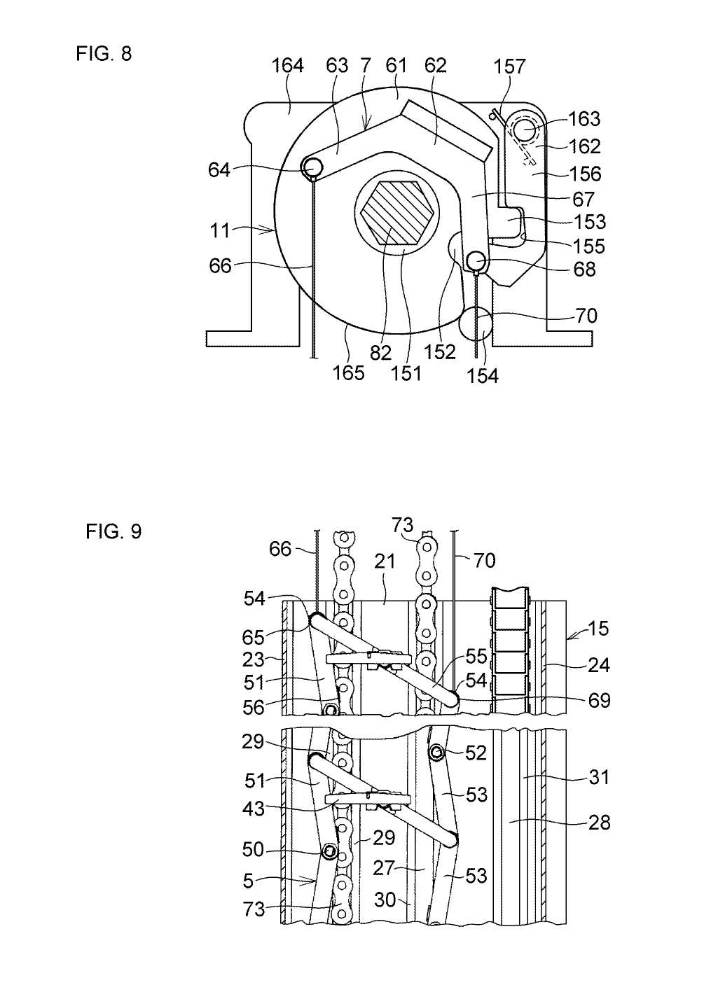

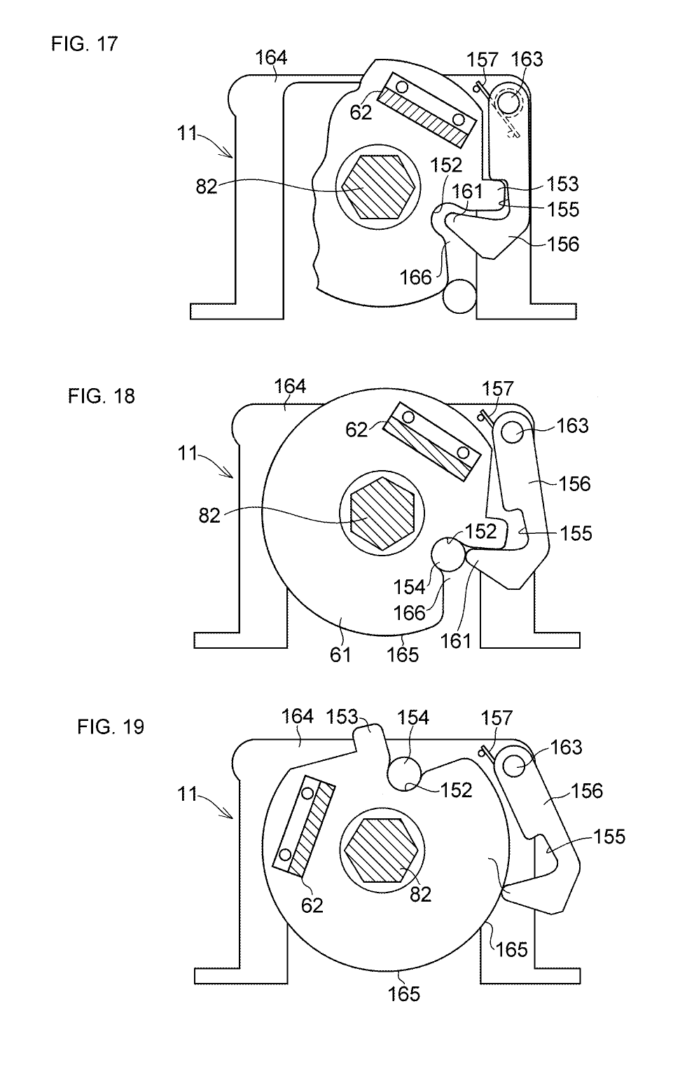

The tilting mechanism 11 includes the swingable member 61 which is provided on the rotating shaft 82 so as to be swingable (rotatable) about the rotating shaft 82 with respect to the rotating shaft 82 through a bearing 151 and which has a recess 152 and a projection 153; a projection 154 attached to the chain 73 and fitting in the recess 152 in the traveling of the chain 73 in the direction B; a latch member 156 which has a recess 155 and which, when the projection 154 is not fitted in the recess 152, as shown in FIGS. 8 and 17, is engaged with the projection 153 at that recess 155 so as to be set in a swinging inhibiting state, shown in FIG. 8, to inhibit the swinging (rotation) of the swingable member 61 about the rotating shaft 82, whereas, when the projection 154 is fitted in the recess 152, as shown in FIG. 18, the latch member 156 is rotated by the projection 154 and cancels the engagement of the recess 155 with the projection 153, so as to be set in a swinging allowing state, shown in FIG. 18, to allow the swinging of the swingable member 61; and a resilient means 157 for imparting resiliency to the latch member 156 so as to set the latch member 156 in the swinging motion inhibiting state.

The swingable member 61 is disposed concentrically with the sprocket wheel 76. The latch member 156 having a pawl portion 161 (see FIG. 17) at one end thereof is attached at the other end 162 thereof to a support plate 164 through a shaft member 163 rotatably about the shaft member 163. The support plate 164 is attached to an upper end of the vertical frame 15 between the swingable member 61 and the sprocket wheel 76. The resilient means 157 is constituted by a coil spring which is disposed with one end retained by the support plate 164, the other end retained by the latch member 156, and a central portion wound around the shaft member 163, and the resilient means 157 imparts resiliency to the latch member 156 so as to rotate the latch member 156 about the shaft member 163 to thereby allow the pawl portion 161 to move toward the recess 152.

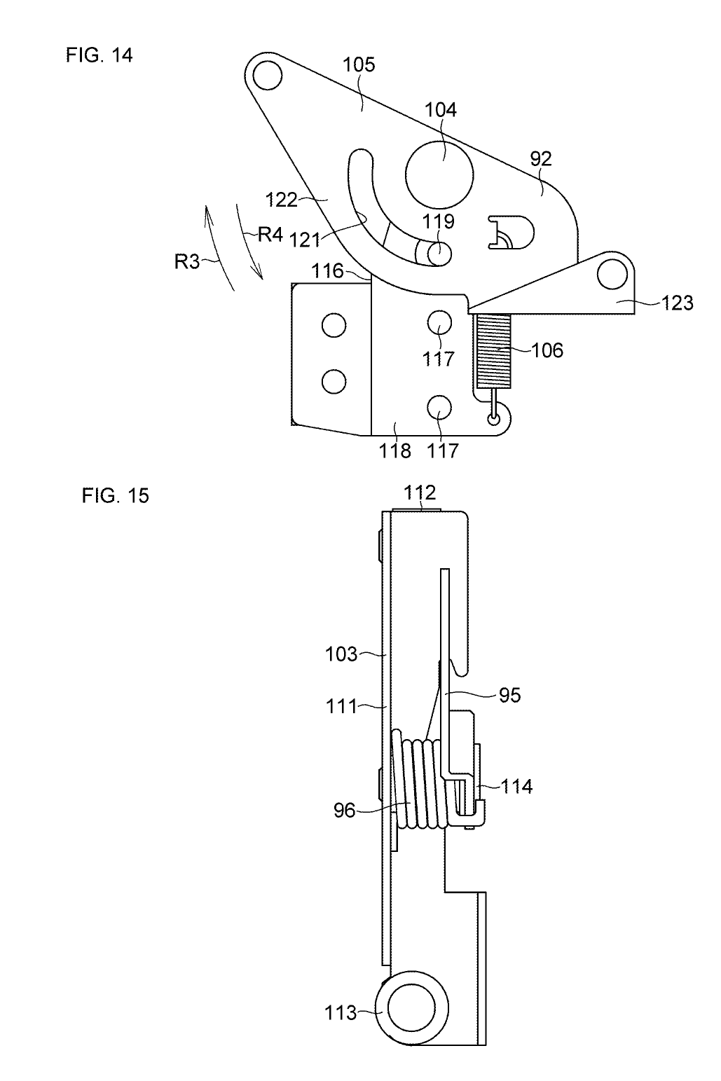

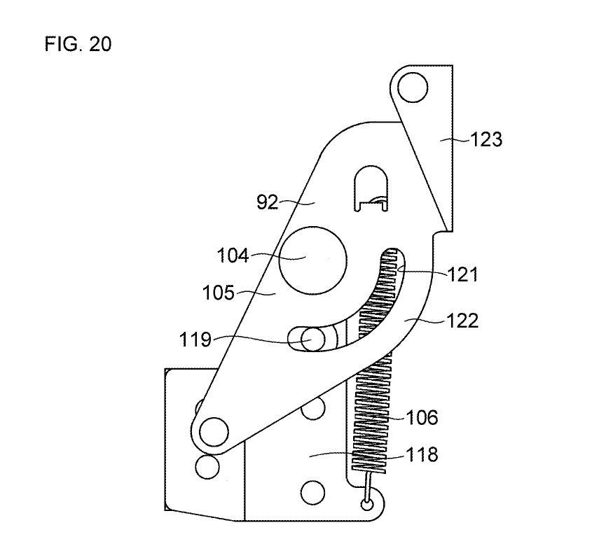

The tilting mechanism 11 is configured as follows: As the chain 73 travels in the direction B, the projection 154 is fitted into the recess 152, as shown in FIG. 18, to rotate the latch member 156 against the resiliency of the resilient means 157, to thereby cancel the engagement of the projection 153 with the recess 155. As a result of this cancellation, the swingable member 61 is swung in conjunction with the movement of the projection 154, as shown in FIG. 19. The series of rear edge link members 53 are relatively raised with respect to the series of front edge link members 51 against the resiliency of the coil spring 106 by means of the cord-like member 70 which is pulled upward by this swinging motion. Meanwhile, the series of front edge link members 51 are relatively lowered with respect to the series of rear edge link members 53 by means of the cord-like member 66 which is lowered downward. The slats 4 are thus adapted to be synchronously tilted to a vertical state, as shown in FIG. 22, by means of the transverse members 55 which are connected to the front edge link members 51 and the rear edge link members 53 so as to close the opening portion 2 by the slats 4. When the opening portion 2 is closed by the slats 4, the swingable member 105 is swung in the R4 direction from the position shown in FIG. 14 to the position shown in FIG. 20.

The sprocket wheel on the vertical frame 16 side, which is constructed in the same way as the sprocket wheel 76, is secured to the rotating shaft 82 extending from the vertical frame 15 to the vertical frame 16, and, as for the window blind apparatus 1, the vertical frame 16 side is constructed in the same way as the vertical frame 15 side.

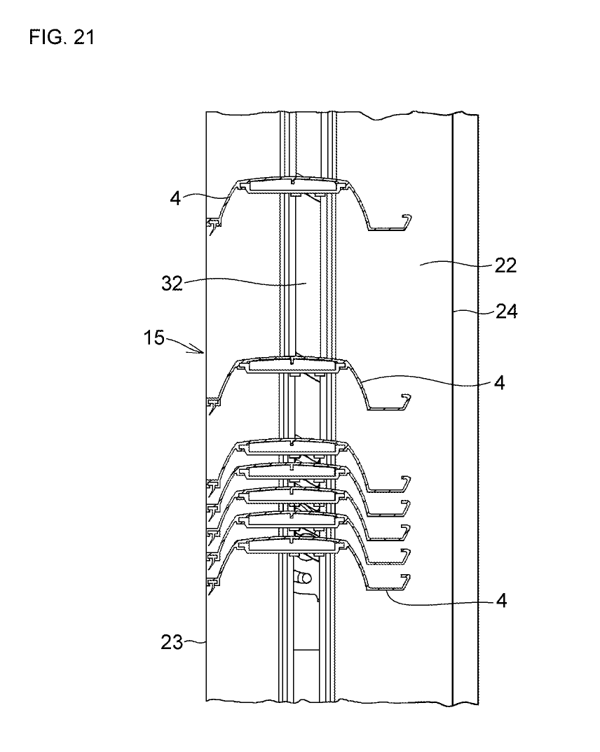

In the above-described window blind apparatus 1, in the state in which the plurality of slats 4 are tilted vertically so as to close the opening portion 2, as shown in FIG. 22, the projection 154 provided on the chain 73 is disposed in the recess 152, as shown in FIG. 19, such that the engagement between the projection 153 and the recess 155 is canceled, and the latch member 156 is brought into contact with an outer peripheral edge 165 of the swingable member 61 and thereby holds the swinging motion allowing state with respect to the swingable member 61. In such a state, when the ball chain 84 is manually operated for traveling in one direction to rotate the sprocket wheel 76 by means of the wheel 83 and the rotating shaft 82, and the chain 73 is rotated in the direction A by this rotation, the projection 154 also moves about the rotating shaft 82 in conjunction with the traveling of the chain 73 in the direction A, and the swingable member 61 is also rotated in the same direction by the movement of the projection 154. This rotation of the swingable member 61 causes the uppermost front edge link member 51 and the series of lower front edge link members 51 connected below the uppermost front edge link member 51 to be relatively raised with respect to the series of rear edge link members 53 by means of the cord-like member 66. Meanwhile, the uppermost rear edge link member 53 and the series of lower rear edge link members 53 connected below the uppermost rear edge link member 53 are relatively lowered with respect to the series of front edge link members 51 by means of the cord-like member 70 while being assisted by the resiliency of the coil spring 106. As a result, the plurality of slats 4 are synchronously tilted and are set in the substantially horizontal state, as shown in FIG. 21. When the plurality of slats 4 are set in the substantially horizontal state, the swingable member 105 is swung in the R3 direction from the position shown in FIG. 20 to the position shown in FIG. 14.

When the chain 73 is further made to travel in the direction A, the projection 154 starts to be disengaged from the recess 152. As the projection 154 is disengaged from the recess 152, the latch member 156 is rotated about the shaft member 163 by the resiliency of the resilient means 157, and the projection 153 and the recess 155 are engaged, as shown in FIGS. 8 and 17, which engagement hampers the rotation of the swingable member 61. As the one end 71 of the chain 73 is raised by the further traveling of the chain 73 in the direction A, the lower front edge link members 51 and the rear edge link members 53 of the link mechanism 5 which is connected to the one end 71 of the chain 73 through the transmitting mechanism 75 start to be folded. As a result of this folding, the plurality of slats 4 connected by the link mechanism 5 are sequentially overlapped from below, as shown in FIG. 21, until all the plurality of slats 4 are raised and overlapped with each other. As the connecting plate 143 collides against the unillustrated stopper provided on the outer side wall portion 21, the manual operation of the ball chain 84 with respect to traveling in one direction is inhibited, and the ratchet mechanism is actuated by the manual operation of the ball chain 84, as required, to maintain the open state of the opening portion 2.

In the traveling of the chain 73 in the direction A, the one end 131 of the no-back chain 133 connected to the one end 72 of the chain 73 through the connecting mechanism 132 is pulled by the one end 72 of the chain 73 and is hence made to travel in the same direction A. As a result, the moving portion 134 of the no-back chain 133 supported on the supporting plate 135 is drawn out from the supporting plate 135, the load in the direction A of this drawn-out moving portion 134 is gradually applied to the one end 72 of the chain 73, and the applied load of the direction A of the drawn-out portion 146 acts as a reaction force to the increasing load in the direction B of the slats 4, the front edge link members 51, the rear edge link members 53, and the transverse members 55. Thus, it becomes possible to assist the traveling of the chain 73 in the direction A and reduce the manual force with respect to the ball chain 84, thereby making it possible to effect the opening of the opening portion 2 with a light manual operating force.

When the ratchet mechanism is released and the ball chain 84 is manually operated reversely to the above in the open state of the opening portion 2, the chain 73 is made to travel in the direction B, and this traveling causes the folding to be sequentially canceled, starting with the upper front edge link members 51 and rear edge link members 53, which start to be extended. As a result, the overlapping of the plurality of slats 4 is sequentially canceled, starting with the upper slats 4. When all the link mechanism 5 is extended, and all the overlapping of the plurality of slats 4 is also canceled, the projection 154 passes through a guide wedge space 166 and is fitted into the recess 152, as shown in FIG. 18. This fitting-in causes the projection 154 to rotate the latch member 156 against the resiliency of the resilient means 157 to thereby cancel the engagement of the projection 153 with the recess 155. As a result of this cancellation, the swingable member 61 is rotated in conjunction with the movement of the projection 154. The rear edge link members 53 are relatively raised with respect to the front edge link members 51 by means of the cord-like member 70 which is pulled in the upward direction A by this rotation. At the same time, the front edge link members 51 are relatively lowered with respect to the rear edge link members 53 by means of the cord-like member 66 which is lowered downward. The plurality of slats 4 are thus synchronously rotated, and the opening portion 2 is set in the closed state by the series of slats 4 which are tilted in the vertical direction, as shown in FIG. 22. Subsequently, as the connecting plate 143 collides against the unillustrated stopper provided on the outer side wall portion 21, the manual operation of the ball chain 84 with respect to traveling in one direction is inhibited, and the ratchet mechanism is actuated by the manual operation of the ball chain 84, as required, to maintain the closed state of the opening portion 2.

Midway in the opening or closing of the opening portion 2, if the traveling of the ball chain 84 is temporarily stopped by the ratchet mechanism, it is possible to effect half opening of the opening portion 2 by the plurality of slats 4.

In the traveling of the chain 73 in the direction B, the one end 131 of the no-back chain 133 is made to travel in the same direction B by being pushed by the one end 72 of the chain 73, with the result that the drawn-out portion 146 of the no-back chain 133 suspended from the supporting plate 135 is accommodated toward the supporting plate 135 and is sequentially supported on the supporting plate 135. Hence, as the moving portion 134 is supported on the supporting plate 135, the load in the direction A of the drawn-out portion 146 applied to the one end 72 of the chain 73 gradually decreases together with the decreasing load in the direction B of the slats 4, the front edge link members 51, the rear edge link members 53, and the transverse members 55. Thus, it becomes possible to effect the closing of the opening portion 2 with a light constant operating force without hampering the traveling of the chain 73 in the direction B and without affecting the manual force with respect to the ball chain 84.

Thus, with the window blind apparatus 1 in accordance with this embodiment, the raising and lowering of the lowermost slat 8 in the vertical direction V by the raising and lowering mechanism 9 is adapted to be effected by the reaction force imparted from the reaction force generating mechanism 10 and by the raising and lowering force imparted to the raising and lowering mechanism 9 from outside by the ball chain 84 of the rotational force imparting mechanism 77. As the other suspended portion 87 of the chain 73 suspended from the sprocket wheel 76 travels in the direction A, i.e., the downward direction, the moving portion 134 of the no-back chain 133 supported on the supporting plate 135 is drawn out from the supporting plate 135, so that the support thereof on the supporting plate 135 is adapted to be gradually released. Thus, the reaction force generating mechanism 10 is adapted to allow the load of the drawn-out portion 146 being drawn out from the supporting plate 135 in the no-back chain 133 to be imparted to the raising and lowering mechanism 9 as a reaction force. Consequently, even if the number of the slats 4 being raised in the opening of the opening portion 2 by the plurality of slats 4 increases, the opening of the opening portion 2 by the plurality of slats 4 can be effected with a substantially constant manual operating force without enlarging the raising and lowering force imparted to the raising and lowering mechanism 9, i.e., the operator's manual operating force with respect to the ball chain 84, thereby making it possible to overcome the difficulty of manual operation by the operator.

In addition, in the window blind apparatus 1 in accordance with this embodiment, since the enlarged hole portion 127, into and from which the enlarged head portion 101 of the pin 102 can be inserted and withdrawn, is formed in the end portion 126 of the elongated hole 125 located on the other end 94 side of the rotating arm member 95, the rotating arm member 95 can be easily connected and disconnected, so that maintenance and inspection, in addition to fabrication and assembly, of the apparatus can be facilitated.

In the window blind apparatus 1, the rotating arm member 95 is disposed such that, in the rotation in the R1 direction, the pin 102 of the traveling member 91 moves through the elongated hole 125 from the one end 93 side toward the other end 94 side of the rotating arm member 95 to an extent of not reaching the enlarged hole portion 127. Therefore, it is possible to eliminate the possibility of the pin 102 from coming off the enlarged hole portion 127 when the traveling member 91 is displaced in the vertical direction V with respect to the movable body 92 on the basis of the traveling of the chain 73. Meanwhile, when the traveling member 91 and the movable body 92 are removed from the window blind apparatus 1, as the enlarged head portion 101 of the pin 102 is withdrawn from or inserted into the enlarged hole portion 127 of the elongated hole 125, it is possible to easily effect the connection and disconnection of the rotating arm member 95 with respect to the traveling member 91.

Although, in the window blind apparatus 1 in accordance with the above-described embodiment, the reaction force generating mechanism 10 is configured by including the no-back chain 133 and the supporting plate 135, the reaction force generating mechanism 10 may alternatively be configured by including another rotating body equivalent to the sprocket wheel 76 and a flexible elongated weight which is equivalent to the chain 73 or the no-back chain 133 and is wound around this other rotating body. In this case, the one end 71 of the one suspended portion 86, suspended from the sprocket wheel 76, of the chain 73 wound around the sprocket wheel 76 is connected to the lowermost slat 8 among the plurality of slats 4, while one end of one suspended portion, suspended from the other rotating body, of the weight equivalent to the chain 73 or the no-back chain 133 and wound around the other rotating body is connected to the one end 72 of the other suspended portion 87, suspended from the sprocket wheel 76, of the chain 73 wound around the sprocket wheel 76, while one end of the other suspended portion, suspended from the other rotating body, of the weight wound around the other rotating body is formed as a free end. Thus, the reaction force generating mechanism 10 may be so adapted that a difference between the load of the one suspended portion, suspended from the other rotating body, of the weight wound around the other rotating body and the load of the other suspended portion, suspended from the other rotating body, of the weight wound around the other rotating body is imparted to the raising and lowering mechanism 9 as a reaction force.

In addition, the window blind apparatus 1 is so adapted that the lowermost slat 8 in the vertical direction V among the plurality of slats 4 in the opening portion 2 is precedingly raised to open the opening portion 2, while that lowermost slat 8 is precedingly lowered to close the opening portion 2. However, as described in JP-A-2011-132806, the window blind apparatus may be may be configured as follows: The lowermost slat 8 among the plurality of slats is connected and fixed to the lower frame 19 of the frame body 3, and in the open state of the opening portion 2, the plurality of slats 4 are disposed in such a manner as to overlap with each other on the lower side of the opening portion 2. At the time of closing the opening portion 2, the opening portion 2 is closed by precedingly raising the uppermost slat 6 in the vertical direction V among the plurality of slats 4 overlapped with each other in the opening portion 2 and by consecutively raising the remaining lower slats 4 in a drawing manner through the link mechanism 5 as the uppermost slat 6 is raised, whereas, at the time of opening the opening portion 2, the opening portion 2 is opened by precedingly lowering the aforementioned uppermost slat 6 and by consecutively lowering the remaining lower slats 4 in a drawing manner through the link mechanism 5 as the uppermost slat 6 is lowered. In such a window blind apparatus, the one suspended portion 86 of the chain 73 suspended from the sprocket wheel 76 also serves to perform the function of the above-described suspending mechanism 7.

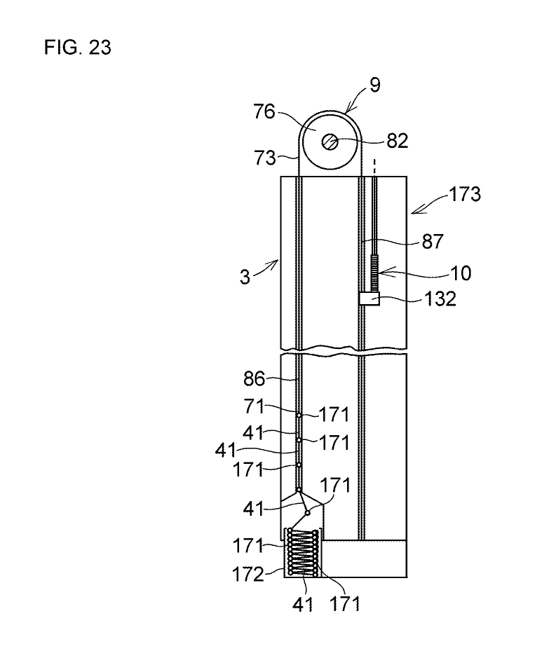

Further, instead of the link mechanism 5 which connects the respective longitudinal end portions 42 of the slat bodies 41 adjacent to each other in the vertical direction V and has the front edge link members 51, the rear edge link members 53, and the like, the connecting mechanism may be a kind of hinge mechanism configured in such a manner as to rotatably connect upper and lower longitudinal edges of the slat bodies 41 adjacent to each other in the vertical direction V and to be able to specify the alternate folding direction (rotating direction) of such mutually connected slat bodies 41. In addition, as shown in FIG. 23, the opening/closing apparatus for an opening portion may be, instead of the window blind apparatus 1, a shutter apparatus 173 in which the series of slats 4 constituted by the plurality of slat bodies 41 connected to each other by hinge mechanisms 171 of the above-described kind are folded and accommodated in the lower frame 19 of the frame body 3, and the slat 4 at one of the series of the plurality of slats 4 folded and accommodated in such a lower frame 19 is connected to the one end 71 the one suspended portion 86, suspended from the sprocket wheel 76, of the chain 73 of the raising and lowering mechanism 9. With this shutter apparatus 173 as well, the raising and lowering of the slats 4 in the vertical direction V is adapted to be effected by the reaction force imparted from the reaction force generating mechanism 10 and the raising and lowering force imparted to the raising and lowering mechanism 9 from outside by the ball chain 84 of the rotational force imparting mechanism 77, and the tilting mechanism 11 can be omitted in such a shutter apparatus 173.

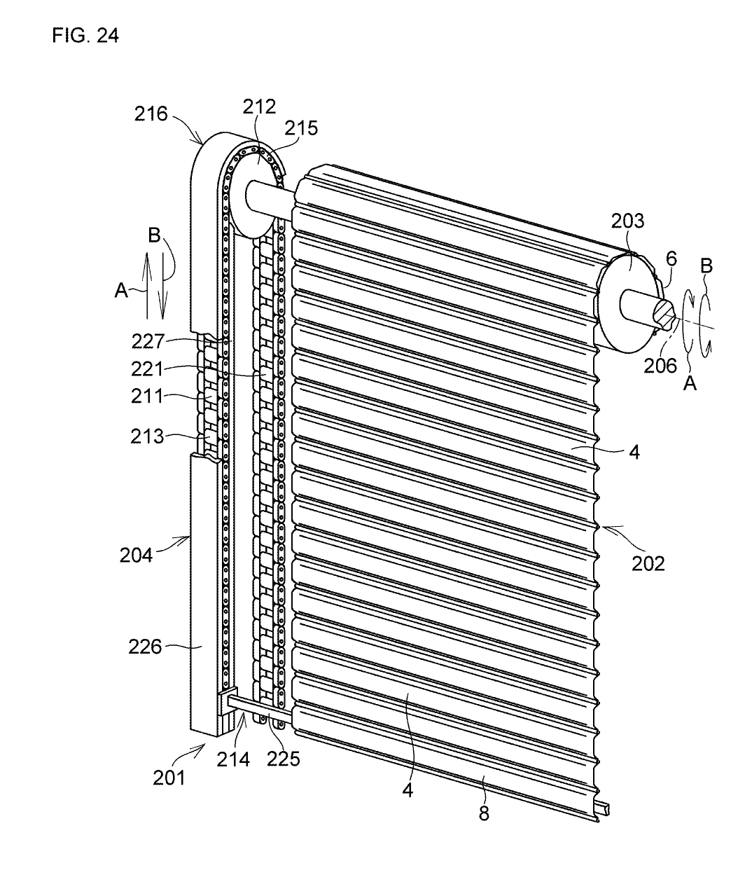

As shown in FIG. 24, the opening/closing apparatus for an opening portion may be, instead of the shutter apparatus 173 shown in FIG. 23, a shutter apparatus 201 in which the opening portion 2 is adapted to be opened or closed by simultaneously raising or lowering the plurality of slats 4 in the opening portion 2. The shutter apparatus 201, which has the frame body 3 (see FIG. 1) defining the opening portion 2 and the plurality of slats 4 in the same way as described above, includes a connecting mechanism 202 for connecting the slats 4 to each other, a rotatable winding member 203 for winding up the plurality of slats 4, and a reaction force generating mechanism 204 for generating a reaction force which increases in correspondence with a change of the number of the slats 4 being raised in the opening portion 2 and is oriented in an opposite direction to the direction of the load of the slats 4 in the opening portion 2.

The connecting mechanism 202 is constituted by a publicly known interlocking type connecting mechanism or overlapping type connecting mechanism which is known by interlocking type slats or overlapping type slats. Such a connecting mechanism 202 is adapted to inhibit the rotation of one slat 4 between the mutually connected adjacent pair of slats 4 in excess of approximately 180° with the connecting mechanism 202 of the other slat 4 as an axis and to allow the rotation of the other slat up to approximately 360°, thereby providing directionality to the bending of the mutually connected slats by more than approximately 180°.

The winding member 203 disposed inside the upper frame 17 between the vertical frames 15 and 16 is constituted by a cylindrical body mounted on the rotating shaft 82 rotatably in the directions A and B about an axis 206 of the rotating shaft 82. The winding member 203 is adapted to consecutively wind up the plurality of slats 4 in the opening 2, starting with the uppermost slat 6 side by the rotation in the direction A in the closing of the opening portion 2 and, meanwhile, to pay out the wound slats 4, starting with the lowermost slat 8 side, to the opening portion 2 by the rotation in the direction B in the opening of the opening portion 2. One edge of the uppermost slat 6 among the plurality of mutually connected slats 4 is secured to the winding member 203.

The reaction force generating mechanism 204 disposed inside the vertical frame 15 includes a chain 211 serving as a flexible elongated weight capable of traveling; a sprocket wheel 212 serving as a rotating body around which the chain 211 is wound and is mounted on the rotating shaft 82 rotatably in the directions A and B so as to be rotated in the directions A and B as the chain 211 travels in the directions A and B; a connecting mechanism 214 which connects one end, i.e., a lower end, of one suspended portion 213 of the chain 211 suspended from the sprocket wheel 212 to the lowermost slat 8 among the plurality of slats 4 in the opening portion 2, so as to transmit the movement in the directions A and B of the suspended portion 213 to the lowermost slat 8 among the plurality of slats 4 in the opening portion 2 and, meanwhile, to transmit the movement in the directions A and B of the plurality of slats 4 in the opening portion 2 to the suspended portion 213; and an inhibiting mechanism 216 for inhibiting unintentional deflection of the suspended portion 213 of the chain 211 and unintentional radial projection of a wound-around portion 215 of the chain 211 around the sprocket wheel 212.

The chain 211 consists of a row of chain elements in which chain elements serving as a plurality of weight elements having a mutually identical mass are rotatably connected to each other in series. One end of the other suspended portion 221 of the chain 211 suspended from the sprocket wheel 212 is formed as a free end. In a state in which the opening portion 2 is completely closed by the plurality of slats 4, the chain 211 is wound around the sprocket wheel 212 such that the suspended portion 221 has a length equivalent to the length of the suspended portion 213. Thus, in the state in which the opening portion 2 is completely closed by the plurality of slats 4, the chain 211 is adapted to not cause the movement of the suspended portion 213 and the suspended portion 221 in the directions A and B.

The sprocket wheel 212 mounted on the rotating shaft 81 rotatably in the directions A and B meshes with the chain 211 at the wound-around portion 215.

The connecting mechanism 214 has a connecting rod 225 which has end secured to a lower end of the suspended portion 213 and the other end secured to a lateral end of the lowermost slat 8 among the plurality of slats 4 for closing the opening portion 2 and is passed through the slit 32. The connecting mechanism 214 is adapted to transmit the manual lifting movement and lowering movement of the lowermost slat 8 among the plurality of slats 4 to the lower end of the suspended portion 213 and to transmit the movement of the suspended portion 213 in the directions A and B to the lowermost slat 8 among the plurality of slats 4.

The inhibiting mechanism 216 has one guide plate 226 mounted on the outer side wall portion 21 by being disposed along the suspended portion 213 and the wound-around portion 215 and one guide plate 227 mounted on the outer side wall portion 21 by being disposed along the suspended portion 213 in such a manner as to sandwich the suspended portion 213 in cooperation with the guide plate 226. The guide plates 226 and 227 opposed to each other with a gap therebetween forms a traveling path for the suspended portion 213 by that gap. The guide plates 226 opposed to each other with the gap therebetween and the sprocket wheel 212 form a traveling path for the wound-around portion 215 by that gap. The suspended portion 213 and the wound-around portion 215 of the chain 211 are adapted to be caused to travel and moved in the directions A and B while being guided and restricted by such traveling paths.

The reaction force generating mechanism 204 may be provided on the vertical frame 16 side as well. In addition, in the shutter apparatus 201 in accordance with this embodiment, unillustrated guiding and restricting members for restricting the displacement in the back-and-forth direction of both side ends of the plurality of slats 4 in the opening portion 2 and guiding the movement of the both side ends in the vertical direction V and for guiding the winding up of the plurality of slats 4 onto the winding member 203 are respectively provided on the inner side wall portions 22 of the vertical frames 15 and 16 and the upper frame 17 so that the plurality of mutually connected slats 4 in the opening portion 2 will not be deflected in the back-and-forth direction and the plurality of slats 4 wound around the winding member 203 will not bulge radially outwardly from the winding member 203 when the lowermost slat 8 among the plurality of slats 4 is lifted and raised manually and by the reaction force generating mechanism 204.

With the above-described shutter apparatus 201, when the lowermost slat 8 among the plurality of slats 4 for closing the opening portion 2 is manually lifted in the direction A in the state in which the opening portion 2 is completely closed by the plurality of slats 4, the plurality of slats 4 in the opening portion 2 are simultaneously raised to gradually open the opening portion 2. Simultaneously therewith, the lower end of the suspended portion 213 is also moved in the direction A through the connecting mechanism 214, and the suspended portion 213 is thereby also made to travel in the direction A. As the sprocket wheel 212 rotates in the direction A in the traveling of the suspended portion 213 in the direction A, the suspended portion 221 is similarly moved in the direction A, and the one end side of the suspended portion 221, which is a free end, starts to be stacked inside the lower frame 19. When the one end side of the suspended portion 221, i.e., the free end, thus starts to be stacked inside the lower frame 19 and, meanwhile, the lower end of the suspended portion 213 is moved in the direction A, the load in the direction A based on the mass of the suspended portion 221 becomes gradually larger as compared with the load in the direction B based on the mass of the suspended portion 213. The force acting in the direction A based on this load difference which becomes gradually larger is transmitted through the connecting mechanism 214 to the lowermost slat 8 among the plurality of slats 4 for closing the opening portion 2. Thus, the raising of the plurality of slats 4 in the opening portion 2 is adapted to be effected by the force generated by the reaction force generating mechanism 204 in the direction A on the basis of the increasing load difference, namely, the reaction force in the opposite direction to the load of the plurality of slats 4 in the opening portion 2.

Further, with the shutter apparatus 201, since the plurality of slats 4 in the opening portion 2 are wound up onto the winding member 203 at the same time as they are raised, the load of the plurality of slats 4 in the opening portion 2 becomes gradually smaller, with the result that the plurality of slats 4 in the opening portion 2 are quickly raised and are wound up onto the winding member 203 even if a large manual force is not applied to the lowermost slat 8 among the plurality of slats 4, for example, allowing the opening portion 2 to be fully opened. The opening operation of the opening portion 2 is stopped by the collision of the connecting rod 225 against an unillustrated stop mechanism, and the open state of the opening portion 2 is thereby maintained.

If the lowermost slat 8 suspended from the winding member 203 among the plurality of slats 4 wound up around the winding member 203 is manually pulled downward in the direction B in the state in which the opening portion 2 is fully open, the lower end of the suspended portion 213 is pulled downward and moved in the direction B through the connecting mechanism 214. As a result, the load in the direction A based on the mass of the suspended portion 221 becomes gradually smaller as compared with the load in the direction B based on the mass of the suspended portion 213, while the lowering force in the direction B based on the increase in the number of the slats 4 paid out from the winding member 203 increases. Hence, the opening portion 2 can be brought to the closed state by the manual pulling down force in the direction B which is made gradually smaller owing to the decrease in the load in the direction A based on the mass of the suspended portion 221 and the increase in the lowering force in the direction B based on the increase in the number of the slats 4. Finally, the opening portion 2 is completely closed as the lowermost slat 8 is brought into contact with the lower frame 19.

As described above, according to the shutter apparatus 201, it is possible to overcome the difficulty in the operator's manual operation in both the opening and closing of the opening portion 2.

Although, in the shutter apparatus 201, both of the winding member 203 and the sprocket wheel 212 are rotatably mounted on the rotating shaft 82, one of the winding member 203 and the sprocket wheel 212 may be secured to the rotating shaft 81, and the other one thereof may be rotatably mounted on the rotating shaft 81. In this case, if the other one of the winding member 203 and the sprocket wheel 212 is mounted on the rotating shaft 82 with appropriate sliding friction, the rotation of one of the winding member 203 and the sprocket wheel 212 can be transmitted to the other one of the winding member 203 and the sprocket wheel 212 with a appropriate frictional force, making it possible to assist the rotation of the other one of the winding member 203 and the sprocket wheel 212, and a difference between the amount of rotation of one of the winding member 203 and the sprocket wheel 212 and the amount of rotation of the other one of the winding member 203 and the sprocket wheel 212 can be favorably overcome by sliding between the rotating shaft 82 and the other one of the winding member 203 and the sprocket wheel 212.

Furthermore, in the shutter apparatus 201, in a case where both of the winding member 203 and the sprocket wheel 212 are rotatably mounted on the rotating shaft 82, the rotating shaft 82 may be a fixed shaft secured to one end of each of the vertical frames 15 and 16. Also, the chain 211 may be a row of chain elements in which chain elements having mutually different masses are connected in series in the order of the magnitude of mass, instead of the row of chain elements in which chain elements having a mutually identical mass are connected in series. Additionally, the suspended portion 221 may be shorter than the suspended portion 213 in the state in which the opening portion 2 is completely closed by the plurality of slats 4.

### DESCRIPTION OF REFERENCE NUMERALS

1: window blind apparatus
2: opening portion
3: frame body
4, 6, 8: slat
5: link mechanism
7: suspending mechanism
9: raising and lowering mechanism
10: reaction force generating mechanism
11: tilting mechanism
72: one end
73: chain
76: sprocket wheel
86, 87: suspended portion
131: one end
132: connecting mechanism
133: no-back chain
134: moving portion
135: supporting plate

1. An opening/closing apparatus for an opening portion comprising:
a frame body which is disposed in an opening portion of a building;
a plurality of slats which are juxtaposed to each other in a vertical direction in the opening portion surrounded by said frame body and which open and close the opening portion;
a connecting mechanism for mutually connecting vertically adjacent ones of said plurality of slats; and
a reaction force generating mechanism for generating a reaction force which increases in correspondence with a change in the number of said slats being raised in the opening portion and is oriented in an opposite direction to a direction of a load of said slats in the opening portion,
wherein the raising of said slats in the opening portion is effected by at least the increasing reaction force generated by said reaction force generating mechanism.

2. The opening/closing apparatus for an opening portion according to claim 1, further comprising a raising and lowering mechanism for raising and lowering said plurality of slats in the opening and closing of the opening portion, wherein said reaction force generating mechanism is adapted to impart to said raising and lowering mechanism the reaction force which increases in correspondence with an increase of the load in the opening portion corresponding to an increase in the number of said slats being raised by said raising and lowering mechanism in the opening portion, and said raising and lowering mechanism is adapted to effect the raising of said slats in the opening portion by the reaction force imparted by at least said reaction force generating mechanism.

3. The opening/closing apparatus for an opening portion according to claim 2, wherein said raising and lowering mechanism is adapted to effect the raising of said slats in the opening portion also by a raising force imparted from an outside in addition to the reaction force.

4. The opening/closing apparatus for an opening portion according to claim 2, wherein said reaction force generating mechanism is adapted to impart to said raising and lowering mechanism the reaction force which decreases in correspondence with a decrease of the load in the opening portion corresponding to a decrease in the number of said slats being lowered by said raising and lowering mechanism in the opening portion.

5. The opening/closing apparatus for an opening portion according to claim 2, wherein said raising and lowering mechanism includes a flexible elongated member, a traveling mechanism for causing the elongated member to travel, and a transmitting mechanism for transmitting the traveling of the elongated member to said slats,
the traveling mechanism including a rotating body around which the elongated member is wound and which causes the elongated member to travel as the rotating body rotates and a rotational force imparting mechanism for imparting a rotational force to the rotating body to rotate the rotating body,
the transmitting mechanism connecting to a slat one end of one suspended portion of the elongated member suspended from the rotating body, so as to transmit the traveling of the elongated member to said slats,
wherein said reaction force generating mechanism includes a flexible elongated weight connected at one end thereof to another suspended portion, suspended from the rotating body, of the elongated member wound around the rotating body, and a supporting member for accommodating a moving portion of the weight which moved as the other suspended portion of the elongated member suspended from the rotating body travels in an upward direction, so as to support that moving portion,
the moving portion of the weight supported on the supporting member being adapted to be drawn out from the supporting member as the other suspended portion of the elongated member suspended from the rotating body travels in a downward direction, so as to allow the support thereof on the supporting member to be gradually released, and
wherein said reaction force generating mechanism is adapted to allow a load of a drawn-out portion of the weight being drawn out from the supporting member to be imparted to said raising and lowering mechanism as the reaction force.

6. The opening/closing apparatus for an opening portion according to claim 2, wherein said raising and lowering mechanism includes a flexible elongated member, a traveling mechanism for causing the elongated member to travel, and a transmitting mechanism for transmitting the traveling of the elongated member to said slats,
the traveling mechanism including a first rotating body around which the elongated member is wound, a rotating mechanism for rotating the first rotating body, and a rotational force imparting mechanism for imparting a rotational force to the rotational mechanism,
the transmitting mechanism connecting to a slat one end of one suspended portion of the elongated member suspended from the first rotating body, so as to transmit the traveling of the elongated member to said slats,
wherein said reaction force generating mechanism includes a second rotating body and a flexible elongated weight wound around the second rotating body,
one end of one suspended portion, suspended from the second rotating body, of the weight wound around the second rotating body being connected to one end of another suspended portion, suspended from the first rotating body, of the elongated member wound around the first rotating body,
one end of another suspended portion, suspended from the second rotating body, of the weight wound around the second rotating body being formed as a free end, and
wherein said reaction force generating mechanism is adapted to allow a difference between a load of the one suspended portion, suspended from the second rotating body, of the weight wound around the second rotating body and a load of the other suspended portion, suspended from the second rotating body, of the weight wound around the second rotating body to be imparted to said raising and lowering mechanism as the reaction force.

7. The opening/closing apparatus for an opening portion according to claim 3, wherein the weight is constituted by a no-back chain.

8. The opening/closing apparatus for an opening portion according to claim 1, wherein a vertically uppermost slat among said plurality of slats in the opening portion is adapted to be precedingly raised to close the opening portion, and the uppermost slat is adapted to be precedingly lowered to open the opening portion.

9. The opening/closing apparatus for an opening portion according to claim 1, wherein a vertically lowermost slat among said plurality of slats in the opening portion is adapted to be precedingly raised to open the opening, and the lowermost slat is adapted to be precedingly lowered to close the opening portion.

10. The opening/closing apparatus for an opening portion according to claim 1, wherein opening/closing apparatus for an opening portion is a window blind apparatus.

11. The opening/closing apparatus for an opening portion according to claim 1, wherein said plurality of slats in the opening portion are adapted to be simultaneously raised or lowered to open or close the opening portion.

12. The opening/closing apparatus for an opening portion according to claim 11, further comprising a rotatable winding member, wherein when the opening portion is closed, said plurality of slats in the opening portion are adapted to be consecutively wound up around the winding member, starting with an uppermost slat, whereas when the opening portion is opened, said slats wound up around the winding member are adapted to be paid out.

13. The opening/closing apparatus for an opening portion according to claim 11, wherein said reaction force generating mechanism is adapted to generate a reaction force which increases in correspondence with the number of the slats which are wound up around the winding member.

14. The opening/closing apparatus for an opening portion according to claim 11, wherein said reaction force generating mechanism includes a flexible elongated weight capable of traveling; a rotatable rotating body around which the weight is wound, so as to allow the rotating body to be rotated as the weight travels; and a connecting mechanism which connects a slat in the opening portion to one suspended portion of the weight suspended from the rotating body, so as to transmit the raising of said slats in the opening portion to the one suspended portion.

15. The opening/closing apparatus for an opening portion according to claim 14, wherein said connecting mechanism is adapted to connect the one end of the suspended portion to a lowermost slat among said plurality of slats in the opening portion.

16. The opening/closing apparatus for an opening portion according to claim 14, wherein, in a state in which the opening is completely closed by said plurality of slats, another suspended portion of the weight suspended from the rotating body has a mass which is equivalent to or greater than a mass of the one suspended portion of the weight suspended from the rotating body.

17. The opening/closing apparatus for an opening portion according to claim 14, wherein one end of the other suspended portion of the weight suspended from the weight is formed as a free end.

18. The opening/closing apparatus for an opening portion according to claim 1, wherein the opening/closing apparatus for an opening portion is a shutter apparatus.
